(19) United States
(12) Patent Application Publication
(10) Pub. No.: US 2003/0011893 A1
(43) Pub. Date: Jan. 16, 2003

(54) Optical system and exposure apparatus equipped with the optical system

(75) Inventors: Naomasa Shiraishi, Saitama-shi (JP); Yasuhiro Omura, Kumagaya-shi (JP)

Correspondence Address: OLIFF & BERRIDGE, PLC, P.O. BOX 19928, ALEXANDRIA, VA, 22320, US

(73) Assignee: Nikon Corporation, Tokyo (JP)

(21) Appl. No.: 10/175,101

(22) Filed: Jun. 20, 2002

Related U.S. Application Data
(60) Provisional application No. 60/308,843, filed on Aug. 1, 2001.

(30) Foreign Application Priority Data
Jun. 20, 2001 (JP) 2001-185825
Jul. 6, 2001 (JP) 2001-206935

(51) Int. Cl. G02B 17/00; G02B 9/00; G02B 3/00

(52) U.S. Cl. 359/726; 359/754; 359/649

(57) ABSTRACT

An optical system attains good optical performance in effect without receiving the effects of birefringence even when using a birefringent crystal material such as fluorite The optical system is provided with a first lens group having a plurality of crystal lenses in which the optical axis and the crystal axis [111] are made to coincide, and a second lens group comprising a plurality of crystal lenses in which the optical axis and the crystal axis [100] are made to coincide. The first lens group has a first A lens group and a first B lens group that have a positional relationship rotated by a first angle relative to each other, and the second lens group has a second lens A group and a second lens B group that have a positional relationship rotated by a second angle relative to each other.

This non-provisional application claims the benefit of U.S. Provisional Application No. 60/308,843 filed Aug. 1, 2001. The disclosures of Japanese Priority Application No. 2001-185825 filed Jun. 20, 2001, and Japanese Priority Application No. 2001-206935 filed Jul. 6, 2001, are incorporated herein by reference in their entireties.

### BACKGROUND OF THE INVENTION

1. Field of Invention

The present invention relates to an optical system and an exposure apparatus equipped with the optical system, and more particularly to a projection optical system suitable for an exposure apparatus used in fabricating microdevices using photolithography techniques.

2. Description of Related Art

When forming the delicate patterns of electronic devices (microdevices) such as semiconductor integrated circuits or liquid crystal displays, a method is employed in which the pattern on a photomask (also called a reticle), on which the pattern to be formed is enlarged proportionally by 4-5 times and etched, is reduced, exposed and transferred onto a photosensitive substrate (the exposure target substrate) of a wafer or the like using a projection exposure apparatus. With this type of projection exposure apparatus, the wavelength of the exposure light is being shifted toward shorter wavelengths in order to cope with the increasing fineness of semiconductor integrated circuits.

At present, the mainstream for exposure light wavelengths is 248 nm of a KrF excimer laser, but ArF excimer lasers with a shorter wavelength of 193 nm are reaching the stage of becoming practical. Moreover, proposals are also being made for projection exposure apparatus that use light sources for supplying light in the wavelength band known as the vacuum ultraviolet region, such as F2 lasers with a 157 nm wavelength and Ar2 lasers with a 126 nm wavelength. In addition, because higher resolutions become possible by enlarging the numerical aperture (NA) of a projection optical system, projection optical systems having larger numerical apertures are also being developed along with development of systems with shorter exposure wavelengths.

Optical materials (lens materials) with good transmissivity and uniformity with respect to exposure light in the short wavelength ultraviolet region are limited. In a projection exposure system having an ArF excimer laser as the light source, it is possible to use synthetic quartz glass as the lens material, but calcium fluoride crystals (fluorite) are used in a portion of the lenses because it is impossible to correct chromatic aberrations adequately with only one type of lens material. On the other hand, in a projection optical system with an F2 laser as the light source, for all practical purposes the usable lens material is limited to calcium fluorite crystals (fluorite).

### SUMMARY OF THE INVENTION

Recently, it has been reported that birefringence occurs even in calcium fluoride crystals (fluorite), which is a cubic system, for ultraviolet rays with a short wavelength. In very high precision optical systems such as projection optical systems used in manufacturing electronic devices, aberrations that occur accompanying birefringence of lens materials are fatal, so utilization of lens compositions and lens designs that effectively avoid the effects of birefringence is indispensable.

In consideration of the foregoing problems, it is one object of the present invention to provide an optical system that can attain good optical performance without receiving the effects of birefringence even when using a birefringent crystal material such as fluorite, and an exposure apparatus equipped with the optical system. In addition, it is another object of the present invention to provide a microdevice fabrication method that can fabricate high-performance microdevices in accordance with high-resolution exposure technology by using an exposure apparatus incorporating an optical system using crystal materials and having good optical performance.

In order to address the foregoing problems, a first aspect of the present invention provides an optical system that includes a plurality of optical elements formed of a crystal belonging to a cubic system, comprising:

a first element group composed of a plurality of optical elements arranged such that the optical axis of the optical system substantially coincides with a crystal axis [111] of the system or a crystal axis optically equivalent to the crystal axis; and

a second element group composed of a plurality of optical elements arranged such that the optical axis substantially coincides with a crystal axis [100] or a crystal axis optically equivalent to the crystal axis; and wherein

the first element group has a first A element group and a first B element group having a positional relationship rotated relative to each other by a first angle about the optical axis; and

the second element group has a second A element group and a second B element group having a positional relationship rotated relative to each other by a second angle about the optical axis;

the optical path length L1A, of light beams forming an angle of predetermined range with respect to the optical axis, in the optical elements in the first A element group, and the optical path length L1B of the light beams in the optical elements in the first B element group are substantially equal; and

the optical path length L2A, of light beams forming an angle of predetermined range with respect to the optical axis, in the optical elements in the second A element group, and the optical path length L2B of the light beams in the optical elements in the second B element group are substantially equal; and

the optical path length L1 (=L1A+L1B), of light beams having an angle of the predetermined range with respect to the optical axis, in the optical elements in the first element group and the optical path length L2 (=L2A+L2B) of the light beams in the optical elements in the second element group are set in accordance with a predetermined magnification.

With a preferred configuration of the first aspect of the invention, the optical path length L1 in the optical elements in the first element group is set to approximately 1.5 times the optical path length L2 in the optical elements in the second element group. In this case, it is preferable for the difference between 1.5 times the optical path length L2 in the optical elements in the second element group and the optical path length L1 in the optical elements in the first element group to be set so as to not be greater than ±1.0×10⁻⁶×λ³ (cm), where λ (nm) is the wavelength of the light beam.

In addition, with a preferred configuration of the first aspect of the invention, the difference between the optical path length L1A in the optical elements in the first A element group and the optical path length L1B in the optical elements in the first B element group is set so as to not be greater than ±0.5×10⁻⁶×λ³ (cm), where λ (nm) is the wavelength of the light beam. Furthermore, it is preferable for the difference between the optical path length L2A in the optical elements in the second A element group and the optical path length L2B in the optical elements in the second B element group to be set so as to not be greater than ±0.5×10⁻⁶×λ³ (cm), where λ (nm) is the wavelength of the light beam. Moreover, it is preferable for the angle within the predetermined range to be larger than an angle corresponding to 0.6 times the image-side numerical aperture of the optical system while being smaller than an angle corresponding to 0.9 times the image-side numerical aperture.

Furthermore, with the preferred configuration of the first aspect of the invention, the first A element group and the first B element group are positioned close to each other along the optical axis, and the second A element group and the second B element group are positioned close to each other along the optical axis. In addition, it is preferable for the first element group and the second element group to be positioned close to each other along the optical axis. Furthermore, it is preferable for at least one of the element groups out of the first A element group, the first B element group, the second A element group and the second B element group to be composed of a plurality of optical elements arranged close to each other along the optical axis. Moreover, it is preferable for a plurality of sets of the first element group and the second element group to be provided.

A second aspect of the present invention provides an optical system that includes a plurality of optical elements formed of crystals belonging to a cubic system, comprising:

a third element group and a fourth element group each composed of a plurality of optical elements set up such that the optical axis of the optical system substantially coincides with a crystal axis [110] of the system or a crystal axis optically equivalent to the crystal axis; and wherein

the third element group has a third A element group and a third B element group having a positional relationship rotated relative to each other by a third angle about the optical axis; and

the fourth element group has a fourth A element group and a fourth B element group having a positional relationship rotated relative to each other by a fourth angle about the optical axis;

the third element group and the fourth element group have a positional relationship rotated relative to each other by a fifth angle about the optical axis;

the optical path length L3A, of light beams having an angle of predetermined range with respect to the optical axis, in the optical elements in the third A element group, and the optical path length L3B of the light beams in the optical elements in the third B element group are substantially equal; and

the optical path length L4A, of light beams having an angle of the predetermined range with respect to the optical axis, in the optical elements in the fourth A element group, and the optical path length L4B of the light beams in the optical elements in the fourth B element group are substantially equal; and

the optical path length L3 (=L3A+L3B), of light beams having an angle of the predetermined range with respect to the optical axis, in the optical elements in the third element group and the optical path length L4 (=L4A+L4B) of the light beams in the optical elements in the fourth element group are set in accordance with a predetermined magnification.

With one preferred configuration of the second aspect of the invention, the optical path length L3 in the optical elements in the third element group and the optical path length L4 in the optical elements in the fourth element group are set substantially equal to each other. In this case, it is preferable for the difference between the optical path length L3 in the optical elements in the third element group and the optical path length L4 in the optical elements in the fourth element group to be set so as to not be greater than ±1.0×10 ⁻⁶×λ³ (cm), where λ (nm) is the wavelength of the light beam.

In addition, with one preferred configuration of the second aspect of the invention, the difference between the optical path length L3A in the optical elements in the third A element group and the optical path length L3B in the optical elements in the third B element group is set so as to not be greater than ±0.5×10⁻⁶×λ³ (cm), where λ (nm) is the wavelength of the light beam. Moreover, it is preferable for the difference between the optical path length L4A in the optical elements in the fourth A element group and the optical path length L4B in the optical elements in the fourth B element group to be set so as to not be greater than ±0.5×10⁻⁶×λ³ (cm), where λ (nm) is the wavelength of the light beam.

Furthermore, with one preferred configuration of the second aspect of the invention, the optical system further comprises a fifth element group composed of a plurality of optical elements set up so that the optical axis substantially coincides with a crystal axis [100]; wherein the fifth element group has a fifth A element group and a fifth B element group having a positional relationship rotated relative to each other by a sixth angle about the optical axis; the optical path length L5A, of light beams having an angle of predetermined range with respect to the optical axis, in the optical elements in the fifth A element group, and the optical path length L5B of the light beams in the optical elements in the fifth B element group are substantially equal; and a total optical path length L34 (=L3+L4), which is the sum of the optical path length L3 (=L3A+L3B), of light beams having an angle of the predetermined range with respect to the optical axis, in the optical elements in the third element group and the optical path length L4 (=L4A+L4B) of the light beams in the optical elements in the fourth element group, and the optical path length L5 (=L5A+L5B) in the optical elements in the fifth element group are set in accordance with a predetermined magnification.

In this case, the total optical path length L34 in the optical elements in the third element group and the fourth element group is set to approximately 4 times the optical path length L5 in the optical elements in the fifth element group. In addition, in this case it is preferable for the difference between 4 times the optical path length L5 in the optical elements in the fifth element group and the total optical path length L34 in the optical elements in the third element group and the fourth element group to be set so as to not be greater than ±2.7×10 ⁻⁶×λ³ (cm), where λ (nm) is the wavelength of the light beam. Moreover, it is preferable for the difference between the optical path length L5A the optical elements in the fifth A element group and the optical path length L5B in the optical elements in the fifth B element group to be set so as to not be greater than ±0.5×10⁻⁶×λ³ (cm), where λ (nm) is the wavelength of the light beam.

With the preferred configuration of the second aspect of the invention, the angle within the predetermined range is larger than an angle corresponding to 0.6 times the image-side numerical aperture of the optical system while being smaller than an angle corresponding to 0.9 times the image-side numerical aperture. Furthermore, it is preferable for the third A element group and the third B element group to be positioned close to each other along the optical axis, and the fourth A element group and the fourth B element group to be positioned close to each other along the optical axis. In addition, it is preferable for the third element group and the fourth element group to be positioned close to each other along the optical axis. Furthermore, it is preferable for at least one of the element groups out of the third A element group, the third B element group, the fourth A element group and the fourth B element group to be composed of a plurality of optical elements arranged close to each other along the optical axis. Moreover, it is preferable for a plurality of sets of the third element group and the fourth element group to be provided. Furthermore, it is preferable for the fifth A element group and the fifth B element group to be positioned mutually close to each other along the optical axis.

A third aspect of the present invention provides an optical system that includes a plurality of optical elements formed of crystals belonging to a cubic system, comprising:

a sixth element group, a seventh element group, an eighth element group and a ninth element group, each composed of a plurality of optical elements arranged such that the optical axis of the optical system substantially coincides with a crystal axis [110] or a crystal axis optically equivalent to the crystal axis, and wherein:

the seventh element group has a positional relationship rotated by a seventh angle in a predetermined direction about the optical axis with respect to the sixth element group;

the eighth element group has a positional relationship rotated by the seventh angle in a predetermined direction about the optical axis with respect to the seventh element group;

the ninth element group has a positional relationship rotated by the seventh angle in a predetermined direction about the optical axis with respect to the eighth element group; and,

the optical path length L6 in the optical elements in the sixth element group of light beams forming an angle of predetermined range with respect to the optical axis, the optical path length L7 in the optical elements in the seventh element group of light beams forming an angle of predetermined range with respect to the optical axis, the optical path length L8 in the optical elements in the eighth element group of light beams forming an angle of predetermined range with respect to the optical axis, and the optical path length L9 in the optical elements in the ninth element group of light beams forming an angle of predetermined range with respect to the optical axis, are all substantially equal to each other.

With one preferred configuration of the third aspect of the invention, the difference between any two optical path lengths arbitrarily selected from among the optical path length L6 in the optical elements in the sixth element group, the optical path length L7 in the optical elements in the seventh element group, the optical path length L8 in the optical elements in the eighth element group, and the optical path length L9 in the optical elements in the ninth element group, is set so as to not be greater than ±0.5×10 ⁻⁶×λ³ (cm), where λ (nm) is the wavelength of the light beam.

In addition, with one preferred configuration of the third aspect of the invention, the optical system further comprises a tenth element group composed of a plurality of optical elements arranged such that the optical axis substantially coincides with a crystal axis [100] or a crystal axis optically equivalent to the crystal axis, wherein the tenth element group has a tenth A element group and a tenth B element group having a position relationship rotated relative to each other by an eighth angle about the optical axis; and the optical path length L10A in the optical elements in the tenth A element group of the light beams forming the angle of predetermined range with respect to the optical axis, and the optical path length L10B in the optical elements in the tenth B element group are substantially equal. In this case, it is preferable for the difference between the optical path length L10A in the optical elements in the tenth A element group and the optical path length L10B in the optical elements in the tenth B element group to be set so as to not be greater than ±0.5×10⁻⁶×λ³ (cm), where λ (nm) is the wavelength of the light beam.

In addition, with the preferred configuration of the third aspect of the invention, the total optical path length L69 (=L6+L7+L8+L9), which is the sum of the optical path length L6 in the optical elements in the sixth element group and the optical path length L7 in the optical elements in the seventh element group and the optical path length L8 in the optical elements in the eighth element group and the optical path length L9 in the optical elements in the ninth element group, and the optical path length L10 (=L10A+L10B) in the optical elements in the tenth element group are set in accordance with a predetermined magnification. In this case, it is preferable for the total optical path length L69 in the optical elements in the sixth element group through the ninth element group to be set to approximately 4 times the optical path length L10 in the optical elements in the tenth element group. In addition, in this case it is preferable for the difference between 4 times the optical path length L10 in the optical elements in the tenth element group and the total optical path length L69 in the optical elements in the sixth element group through the ninth element group to be set so as to not be greater than ±2.7×10 ⁻⁶×λ³ (cm), where λ (nm) is the wavelength of the light beam. Furthermore, it is preferable for at least one out of the sixth element group through the ninth element group and the tenth element group to have a plurality of sets.

Furthermore, with the preferred configuration of the third aspect of the invention, the optical system further comprises an eleventh element group composed of a plurality of optical elements arranged such that the optical axis of the optical system substantially coincides with a crystal axis [111] or a crystal axis optically equivalent to the crystal axis, wherein the eleventh element group has an eleventh A element group and an eleventh B element group having a position relationship rotated relative to each other by an eighth angle about the optical axis; and the optical path length L11A in the optical elements in the eleventh A element group of the light beams forming the angle of predetermined range with respect to the optical axis, and the optical path length L11B in the optical elements in the eleventh B element group are substantially equal. In this case, it is preferable for the difference between the optical path length L11A in the optical elements in the eleventh A element group and the optical path length L11B in the optical elements in the eleventh B element group to be set so as to not be greater than ±0.5×10⁻⁶×λ³ (cm), where λ (nm) is the wavelength of the light beam. In addition, it is preferable for the eleventh element group to have a plurality of sets.

In addition, with the preferred configuration of the third aspect of the invention, the sum (=3×L69+8×L11) of three times the total optical path length L69 in the optical elements in the sixth element group through the ninth element group with eight times the optical path length L11 in the optical elements in the eleventh element group is set to approximately 12 times the optical path length L10 in the optical elements in the tenth element group.

In this case, it is preferable for the total optical path length L69 (cm) in the optical elements in the sixth element group through the ninth element group, the optical path length L10 (cm) in the optical elements in the tenth element group and the optical path length L11 (cm) in the optical elements in the eleventh element group to satisfy the condition |3×L69−12×L10+8×L11|≦8.0×10 ⁻⁶×λ³, where λ (mn) is the wavelength of the light beam. In addition, it is preferable for the angle within the predetermined range to be larger than an angle corresponding to 0.6 times the image-side numerical aperture of the optical system while being smaller than an angle corresponding to 0.9 times the image-side numerical aperture.

In preferred configurations of the first through third aspects of the invention, the crystal is a calcium fluoride crystal. In addition it is preferable for the crystal to be a barium fluoride crystal. Furthermore, it is preferable for at least one concave reflective mirror to be provided. In addition, it is preferable for aberration correction to be optimized for the oscillation wavelength of an ArF excimer laser, or for aberration correction to be optimized for the oscillation wavelength of an F2 laser.

A fourth aspect of the present invention relates to an exposure apparatus comprising an illumination system for illuminating a mask and the optical system of any of the first through third aspects of the invention for forming on a photosensitive substrate an image of the pattern formed on the mask.

A fifth aspect of the present invention relates to a microdevice fabrication method comprising an exposure procedure that exposes the pattern on the mask onto the photosensitive substrate using the exposure apparatus of the fourth aspect of the invention and a developing procedure for developing the photosensitive substrate that has been exposed by the exposure procedure.

### BRIEF DESCRIPTION OF THE DRAWINGS

FIG. 1 is a drawing schematically showing the composition of an exposure apparatus provided with the projection optical system according to each embodiment of the present invention.

FIG. 2 is a drawing schematically showing the composition of a projection optical system according to a first embodiment of the present invention.

FIG. 3 is a drawing explaining the crystal axis directions in fluorite.

FIGS. 4a and 4b explain the optical path in fluorite lenses in a projection optical system according to the first embodiment.

FIGS. 5a and 5b explain birefringence when the optical axis of the fluorite lenses coincides with the crystal axis [111].

FIGS. 6a and 6b explain birefringence when the optical axis of the fluorite lenses coincides with the crystal axis [100].

FIGS. 7a and 7b explain the composition of and optical path in a first lens group and a second lens group in a projection optical system according to a variation of the first embodiment.

FIG. 8 is a drawing schematically showing the composition of a projection optical system according to a second embodiment of the present invention.

FIGS. 9a and 9b explain the optical path in fluorite lenses in a projection optical system according to the second embodiment.

FIGS. 10a-10d explain birefringence when the optical axis of the fluorite lenses coincides with the crystal axis [110].

FIG. 11 is a drawing schematically showing the composition of a projection optical system according to a fourth embodiment of the present invention.

FIGS. 12a and 12b explain the optical path in fluorite lenses in a projection optical system according to the fourth embodiment.

FIG. 13 is a flowchart for the method used to obtain a semiconductor device as a microdevice.

FIG. 14 is a flowchart for the method used to obtain a liquid crystal display device as a microdevice.

### DETAILED DESCRIPTION OF PREFERRED EMBODIMENTS

Preferred embodiments of the present invention are described below with reference to the attached drawings.

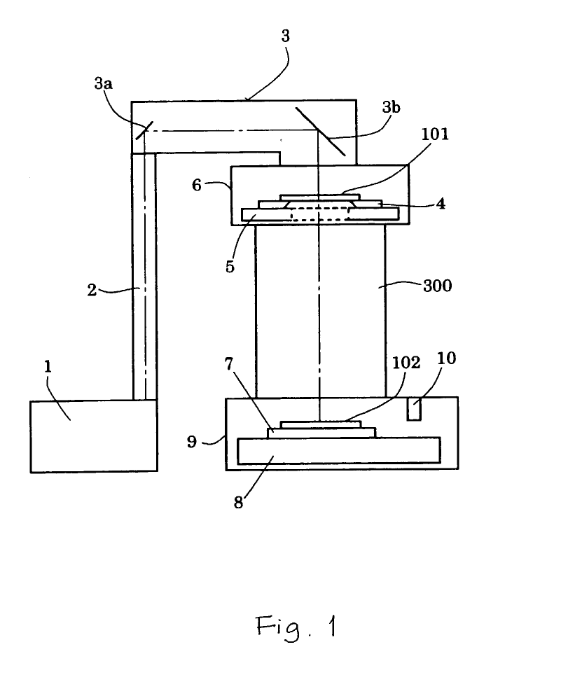

FIG. 1 is a drawing schematically showing the composition of an exposure apparatus equipped with the projection optical system of the preferred embodiments of the present invention. In each of the preferred embodiments, the present invention is applied to the projection optical system mounted in an exposure apparatus. As shown in FIG. 1, the exposure apparatus of each of the preferred embodiments is provided with a light source 1, for example an ArF excimer laser or an F2 laser. The light beam supplied from the light source 1 is guided via a light directing system 2 to an illumination optical system 3. The illumination optical system 3 is composed of folding mirrors 3a and 3b shown in the diagram and unrepresented optical integrators and the like, and illuminates a reticle (mask) 101 with substantially uniform illuminance.

The reticle 101 is held in place on a reticle holder 4 by vacuum adsorption, for example, and is moveable through the action of a reticle stage 5. A light beam that has passed through the reticle 101 is condensed by a projection optical system 300 and forms a projection image of the pattern on the reticle 101 on a photosensitive substrate such as a semiconductor wafer 102. The wafer 102 is also held in place on a wafer holder 7 by vacuum adsorption, for example, and is moveable through the action of a wafer stage 8. Thus, it is possible to successively transfer the projection image of the pattern on the reticle 101 to each exposure area of the wafer 102 by conducting batch exposure while moving the wafer 102 in steps.

Moreover, it is also possible to successively transfer the projection image of the pattern on the reticle 101 to each exposure area of the wafer 102 by conducting scanning exposure while moving the reticle 101 and the wafer 102 relative to the projection optical system 300. When exposing a circuit pattern on an actual electronic device, it is desirable to conduct exposure after precisely aligning the pattern of a subsequent procedure on top of the pattern formed by prior procedures, and hence the exposure apparatus is provided with an alignment microscope 10 for precisely detecting the position of a position detection mark on the wafer 102.

When an F2 laser or an ArF excimer laser (or an Ar2 lasers with a 126 nm wavelength, or the like) is used as the light source 1, the optical path of the light directing system 2, the illumination optical system 3 and the projection optical system 300 is purged with an inert gas such as nitrogen. In particular, when an F2 laser is used, the reticle 101, reticle holder 4 and reticle stage 5 are isolated from the outside atmosphere by a casing 6, and the space inside this casing 6 is purged with an inert gas. Similarly, the wafer 102, wafer holder 7 and wafer stage 8 are isolated from the outside atmosphere by a casing 9, and the space inside this casing 9 is also purged with an inert gas.

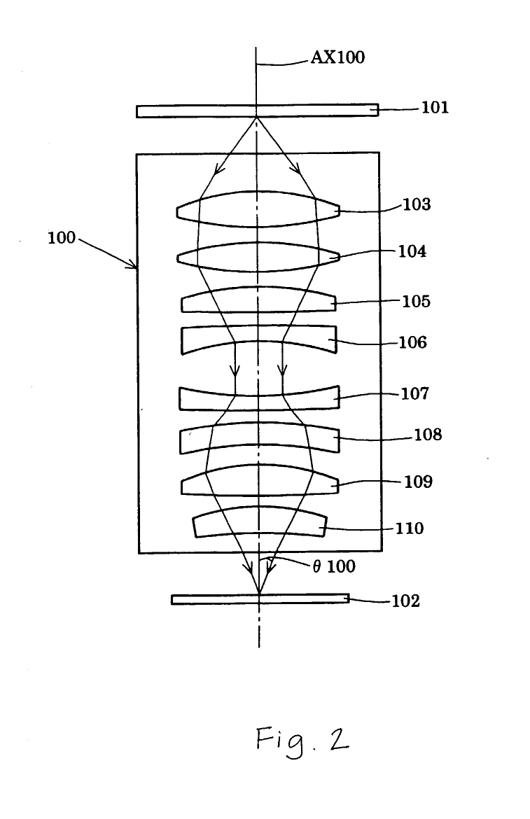

FIG. 2 is a diagram schematically showing the composition of a projection optical system corresponding to a first embodiment of the present invention. In this first embodiment, the present invention is applied to a refractive projection optical system in which aberration correction has been optimized for an ArF laser with a wavelength λ (nm) of 193 nm. In the projection optical system 100 of the first embodiment (which corresponds to the projection optical system 300 in FIG. 1), a light beam exiting one point on the reticle 101 is condensed to one point on the semiconductor wafer 102 that serves as a photosensitive substrate by lenses 103-110 arranged along an optical axis AX100. In this way, the projected image of the pattern etched on the reticle 101 is formed on the wafer 102.

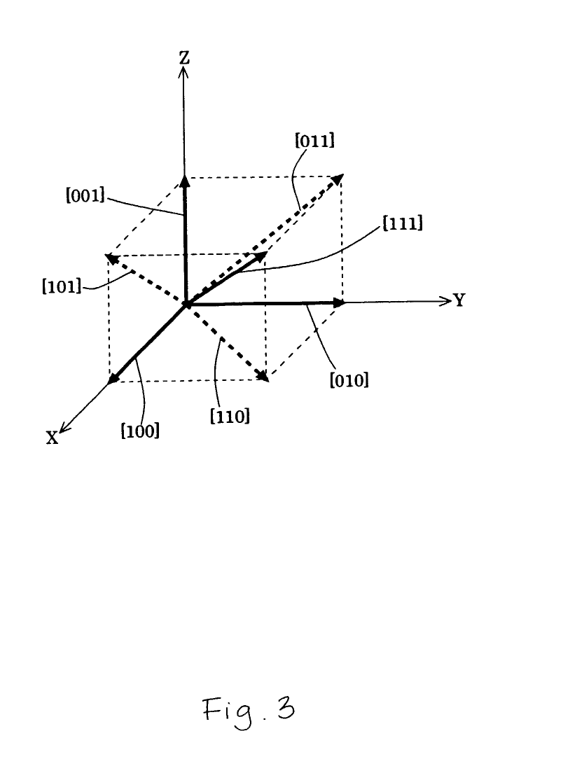

Of lenses 103-110 in this first embodiment, lenses 105, 106, 109 and 110 are formed of calcium fluoride crystals (fluorite), and the remaining lenses are formed of synthetic quartz glass. FIG. 3 is a diagram explaining the crystal axis directions of the fluorite. As shown in FIG. 3, the crystal axes of the fluorite are stipulated based on the XYZ coordinate systems of the cubic system. That is to say, the crystal axis [100] is prescribed to be along the +X axis, the crystal [010] along the +Y axis and the crystal axis [001] along the +Z axis.

A crystal axis [101] is prescribed in the XZ plane in a direction forming a 45° angle with the crystal axis [100] and the crystal axis [001], a crystal axis [110] is prescribed in the XY plane in a direction forming a 45° angle with the crystal axis [100] and the crystal axis [010], and a crystal axis [011] is prescribed in the YZ plane in a direction forming a 45° angle with the crystal axis [010] and the crystal axis [001]. Furthermore, a crystal axis [111] is prescribed in a direction forming an equal acute angle with each of the +X, +Y and +Z axes. In FIG. 3, only the crystal axes in the space prescribed by the +X, +Y and +Z axes are shown, but crystal axes are prescribed similarly in other spaces as well.

In fluorite, birefringence is essentially zero (minimal) on the crystal axis [111] indicated by the solid line in FIG. 3, and on the unrepresented crystal axes [−111], [1-11] and [11-1] equivalent thereto. Similarly, birefringence is essentially zero (minimal) on the crystal axes [100], [010] and [001] indicated by solid lines in FIG. 3. On the other hand, birefringence is a maximum on the crystal axes [110], [101] and [011] indicated by broken lines in FIG. 3, and on the unrepresented crystal axes [−110], [−101] and [01-1] equivalent thereto.

As described above, birefringence (a difference in refractive indices between two light rays having orthogonal planes of polarization) does not occur in light proceeding in the direction of the crystal axis [100] or [111] of the fluorite crystal. Accordingly, if the optical axis AX100 of the projection optical system 100 (and hence the optical axes of the fluorite lenses) are set so as to match the crystal axis [111] or [100] of the fluorite lenses (optical elements), birefringence does not occur in imaging light proceeding parallel to the optical axis AX100. Conversely, birefringence is at a maximum in imaging light proceeding along the crystal axis [011].

With the present invention, when it is necessary to define strictly the relative crystal axis directions, the symbols and arrangement position may be changed and designated (cited) so that the crystal axis [011] and the plurality of crystal axes optically equivalent thereto become [011], [0-11], [110] and so forth. However, when it is not necessary to define strictly the relative crystal axis directions, the plurality of optically equivalent crystal axes, such as [011], [0-11] and [110], may be grouped together and expressed using the notation of the crystal axis [011].

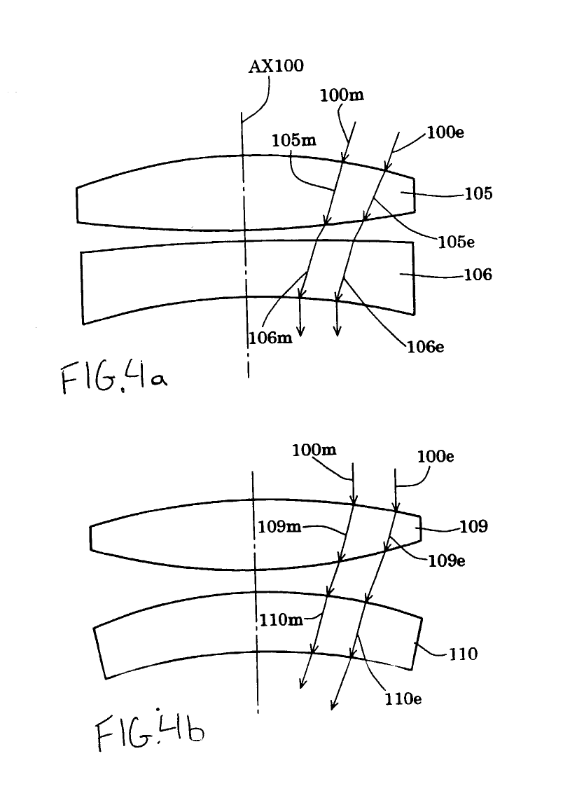

In order to increase the resolution of the projection optical system 100, it is desirable to increase the image-side NA (numerical aperture), which is the sine of the maximum angle of incidence θ100 of light on the wafer 102 (see FIG. 2), to around 0.85, for example. Accordingly, it is impossible to set all of the directions of progress of light rays passing through the projection optical system 100 (and hence the directions of progress of light rays passing through each of the lenses 103-110) parallel to the optical axis AX100. FIG. 4 is a diagram explaining the optical paths in the fluorite lenses within the projection optical system of the first embodiment.

When light is aimed at the fluorite lenses 105, 106, 109 and 110, the optical paths (105e, 106e, 109e and 110e) through the fluorite lenses 105, 106, 109 and 110 of the light beam (the light beam corresponding to the image-side NA) 100e incident on the wafer 102 at the maximum angle of incidence θ100 is not parallel to the optical axis AX100, as shown in FIGS. 4a and 4b. In addition, even for a light beam 100m with an angle of incidence on the wafer 102 that is 60-90% of the maximum angle of incidence θ100 (i.e., the light beam corresponding to around 60-90% of the image-side NA), the optical paths (105m, 106m, 109m and 110m) through the fluorite lenses 105, 106, 109 and 110 are not parallel to the optical axis AX100. As a result, wavefront aberrations caused by the birefringence of the fluorite crystal (hereafter, referred to as simply the “effects of birefringence”) are created on the basis of these light beams that are not parallel to the crystal axis [111].

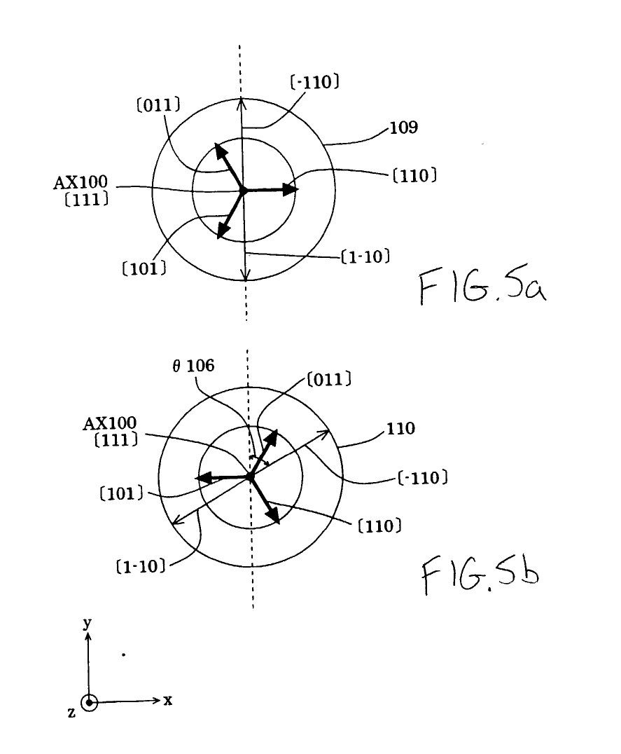

FIG. 5 (FIGS. 5a and 5b) explain birefringence when the optical axis of the fluorite lenses coincide with the crystal axis [111]. As shown in FIG. 5a, the optical axis of the fluorite lens 109 (and hence the optical axis AX100) is set so as to coincide with the crystal axis [111]. Here, the crystal axis [111] is oriented in the upward direction (+Z direction) orthogonal to the plane of the paper in FIG. 5, and the arrows show the orientation of the other crystal axes. At this time, the crystal axes [−110] and [1-10] are arranged in opposite directions in the plane orthogonal to the optical axis AX100. On the other hand, on the side surface of a cone obtained by rotating a directional vector forming an angle of approximately 35° with the optical axis AX100 in the +Z direction about the optical axis AX100, the three optical axes [011], [110] and [101] are arranged with an angular spacing of 120° , with the optical axis AX100 as the center of rotation.

These crystal axes [011], [110] and [101] are crystal axes with a maximum birefringence in light proceeding in that direction, as discussed above. Now, the birefringence is defined as the difference between the index of refraction of light having a plane of polarization along the radial direction of a circle centered at the optical axis AX100 (hereafter abbreviated as “R-polarized light”), and the index of refraction of light having a plane of polarization along the tangential direction of a circle centered at the optical axis AX100 (hereafter abbreviated as “θ-polarized light”). As shown in FIG. 5a, in the fluorite lens 109 having the crystal axis [111] as the optical axis, rotational anisotropy in which the birefringence fluctuates with a 120° period in the tangential direction (rotational direction) is created by the three optical axes [011], [110] and [101] separated by an angular spacing of 120°.

On the other hand, as shown in FIG. 5b, the optical axis of the fluorite lens 110 (and hence the optical axis AX100) is also set so as to coincide with the crystal axis [111]. However, the orientation of the crystal axis [−110] in the plane orthogonal to the optical axis AX100 is rotated by an angle θ106=60° about the −z axis in comparison to the fluorite lens 109 in FIG. 5a. In other words, both the fluorite lens 109 in FIG. 5a and the fluorite lens 110 in FIG. 5b are set so that the optical axis AX100 and the crystal axis [111] coincide, but they have a positional relationship rotated by 60° relative to each other about the optical axis AX100.

As shown in FIG. 5b, with the fluorite lens 110 there is no change in the fact that the rotational anisotropy of the birefringence has a 120° period, but the positions of the maximum and minimum values thereof are rotated by 60° about the optical axis AX100. Hence, by combining two fluorite lenses of the same thickness that both have the crystal axis [111] as the optical axis and have crystal directions that are rotated by 60° relative to each other about the optical axis, the rotational anisotropy with a 120° period that each crystal lens has is offset and a lens group is formed which has substantially the same birefringence amount (difference in indices of refraction between the R-polarized light and the θ-polarized light) for a directional angle centered at the optical axis. This fact was clarified by the inventors of the present invention.

However, this does not mean that the effects of birefringence are eliminated by this structure. As discussed above, this is because only the difference in indices of refraction between the R-polarized light and the θ-polarized light is made substantially uniform for the directional angle centered at the optical axis, while the difference in refractive indices itself remains. According to analysis done by the inventors of the present invention, with two fluorite lenses of the same thickness that both have the crystal axis [111] as the optical axis and have other crystal axes (the crystal axis [−110] orthogonal to the optical axis 111, and the like) rotated by 60° relative to each other, it became known that the index of refraction (nR111) with respect to the R-polarized light is higher than the index of refraction (nθ111) of the θ-polarized light.

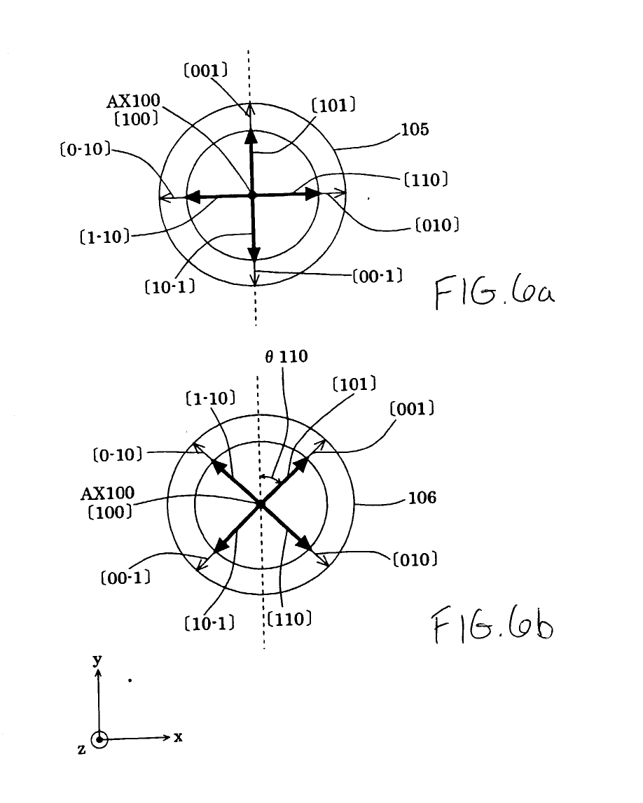

Thus, in the first embodiment, a lens pair (105, 106) having the crystal axis [100] as the optical axis is used in addition to the lens pair (109, 110) having the crystal axis [111] as the optical axis in order to remove the substantially uniform birefringence that remains for the directional angle centered at the optical axis. FIG. 6 (FIGS. 6a and 6b) explain birefringence for the case where the optical axis of the fluorite lenses coincides with the crystal axis [100]. As shown in FIG. 6, the optical axis of the fluorite lens 105 (and hence, the optical axis AX100) is set so as to coincide with the crystal axis [100]. Here, the crystal axis [100] is oriented in the upward direction (+Z direction) orthogonal to the plane of the paper in FIG. 6, and the arrows show the orientation of the other crystal axes.

At this time, the crystal axes [001] and [00-1] are arranged in opposite directions in the plane orthogonal to the optical axis AX100. In addition, the crystal axes [010] and [0-10] are also arranged in opposite directions so as to be orthogonal to the crystal axes [001] and [00-1]. On the other hand, on the side surface of a cone obtained by rotating a directional vector forming an angle of approximately 45° with the optical axis AX100 in the +Z direction about the optical axis AX100, the four optical axes [110], [101], [1-10] and [10-1] are arranged with an angular spacing of 90° with the optical axis AX100 as the center of rotation.

These crystal axes [110], [101], [1-10] and [10-1] are crystal axes with a maximum birefringence for light proceeding in those directions, as discussed above. As shown in FIG. 6a, in the fluorite lens 105 having the crystal axis [100] as the optical axis, rotational anisotropy in which the birefringence fluctuates with a 90° period in the tangential direction (rotational direction) is created by the four optical axes [110], [101], [1-10] and [10-1] separated by an angular spacing of 90°.

On the other hand, as shown in FIG. 6b, the optical axis of the fluorite lens 106 (and hence the optical axis AX100) is also set so as to coincide with the crystal axis [100]. However, the orientation of the crystal axis [001] in the plane orthogonal to the optical axis AX100 is rotated by an angle θ110=45° about the −Z axis in comparison to the fluorite lens 105 in FIG. 6a. In other words, both the fluorite lens 105 in FIG. 6a and the fluorite lens 106 in FIG. 6b are set so that the optical axis AX100 and the crystal axis [100] coincide, but they have a positional relationship rotated by 45° relative to each other about the optical axis AX100.

As shown in FIG. 6b, with the fluorite lens 106 there is no change in the fact that the rotational anisotropy of the birefringence has a 90° period, but the positions of the maximum and minimum values thereof are rotated by 45° about the optical axis AX100. Hence, by combining two fluorite lenses of the same thickness that both have the crystal axis [100] as the optical axis and have crystal directions that are rotated by 45° relative to each other about the optical axis, the rotational anisotropy with a 90° period that each crystal lens has is offset and a lens group is formed which has substantially the same birefringence (difference in indices of refraction between the R-polarized light and the θ-polarized light) for a directional angle centered at the optical axis. This fact was clarified by the inventors of the present invention.

In this case also, however, this does not mean that the effects of birefringence are eliminated by this structure. As discussed above, this is because only the difference in refractive indices between the R-polarized light and the θ-polarized light is made substantially uniform with respect to the directional angle centered at the optical axis, while the difference refractive indices itself remains. According to analysis done by the inventors of the present invention, with two fluorite lenses of the same thickness that both have the crystal axis [100] as the optical axis and have other crystal axes (the crystal axis [001] orthogonal to the optical axis 100, and the like) rotated by 45° relative to each other, it became known that the index of refraction (nR100) with respect to the R-polarized light is lower than the index of refraction (nθ100) of the θ-polarized light.

That is to say, with a lens pair (109, 110) having the crystal axis [111] as the optical axis together with a lens pair (105, 106) having the crystal axis [100] as the optical axis, the sign of the birefringence is reversed. Accordingly, by combining the lens pair (109, 110) having the crystal axis [111] as the optical axis with the lens pair (105, 106) having the crystal axis [100] as the optical axis, it is possible to remove to a certain extent the effects of birefringence. However, the birefringence of the lens pair (105, 106) having the crystal axis [100] as the optical axis, that is to say (nR100-nθ100), and the birefringence of the lens pair (109, 110) having the crystal axis [111] as the optical axis, that is to say (nR111-nθ111), are difference quantities. Accordingly, by setting the optical path length of the lens pair (105, 106) having the crystal axis [100] as the optical axis, and the optical path length of the lens pair (109, 110) having the crystal axis [111] as the optical axis, it is possible to virtually completely remove the effects of birefringence. Specifically, the birefringence of the lens pair (105, 106) having the crystal axis [100] as the optical axis, that is to say (nR100-nθ100), is approximately −1.5 times the birefringence of the lens pair (109, 110) having the crystal axis [111] as the optical axis, that is to say (nR111-nθ111). Consequently, the optical path length of the lens pair (109, 110) having the crystal axis [111] as the optical axis is approximately 1.5 times the optical path length of the lens pair (105, 106) having the crystal axis [100] as the optical axis. By so doing, it is possible to substantially completely remove the effects of birefringence.

In the first embodiment, the above-described relationships are applied to the projection optical system 100 of FIG. 2. That is to say, among the fluorite lenses 105, 106, 109 and 110, the thickness of the fluorite lenses 105 and 106 is set thinner than the thickness of the fluorite lenses 109 and 110. Furthermore, the optical axes of the fluorite lenses 105 and 106 are both made to coincide with the crystal axis [100] of the fluorite, and the optical axis of the fluorite lenses 109 and 110 are both made to coincide with the crystal axis [111] of the fluorite. The fluorite lenses 109 and 110 are set such that the crystal axes [−110] in the plane orthogonal to the optical axis have a positional relationship rotated 60° relative to each other with the optical axis as the center of rotation and the fluorite lenses 105 and 106 are set such that the crystal axes [001] in the plane orthogonal to the optical axis have a positional relationship rotated 45° relative to each other with the optical axis as the center of rotation.

Furthermore, for the light beam 100m corresponding to 60-90% of the image-side NA (maximum NA), that is to say the light beam forming an angle corresponding to 0.6 times to 0.9 times the image-side NA with respect to the optical axis AX100, the difference between the optical path length 105m in the fluorite lens 105 and the optical path length 106m in the fluorite lens 106 is set so as to not be greater than ±0.5×10⁻⁶×λ³ (cm). Similarly, the difference between the optical path length 109m in the fluorite lens 109 and the optical path length 110m in the fluorite lens 110 is set so as to not be greater than ±0.5×10⁻⁶×λ³ (cm). Moreover, the difference between 1.5 times the sum (105m+106m) of the optical path lengths in the second lens group (105, 106) having the crystal axis [100] as the optical axis and the sum (109m+110m) of the optical path lengths in the first lens group (109, 110) having the crystal axis [111] as the optical axis is set so as to not be greater than ±1.0×10⁻⁶×λ³ (cm).

Through this, a uniformity in birefringence for a directional angle centered at the optical axis AX100 is sought in the second lens group (105, 106) having the crystal axis [100] as the optical axis and the first lens group (109, 110) having the crystal axis [111] as the optical axis. Additionally, by combining the second lens group (105, 106) having the crystal axis [100] as the optical axis and the first lens group (109, 110) having the crystal axis [111] as the optical axis, the birefringence amounts that have been made uniform in each with respect to a directional angle centered at the optical axis AX100 offset each other, and as a result it is possible to substantially completely eliminate the effects of birefringence.

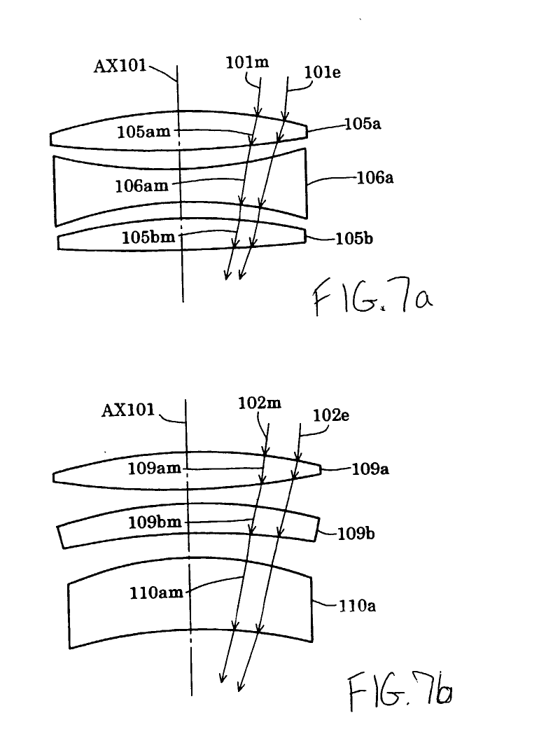

In the above-described first embodiment, the first lens group (109, 110) having the crystal axis [111] as the optical axis and the second lens group (105, 106) having the crystal axis [100] as the optical axis are each composed with one pair of fluorite lenses. However, it is also possible to form at least one out of the first lens group having the crystal axis [111] as the optical axis and the second lens group having the crystal axis [100] as the optical axis from three or more fluorite lenses. FIG. 7 (FIGS. 7a and 7b) explain the composition and optical paths of a first lens group and a second lens group in a projection optical system according to a variation on the first embodiment. Hereafter, this variation of the first embodiment is described with reference to FIG. 7.

As shown in FIG. 7, the second lens group having the crystal axis [100] as the optical axis is composed of a second A lens group comprising a pair of fluorite lenses 105a and 105b, and a second B lens group comprising a single fluorite lens 106a. Here, the fluorite lenses 105a and 105b are such that the orientations of the crystal axes [001] in the plane orthogonal to the optical axis are the same. Furthermore, in the fluorite lens 106a, the orientation of the crystal axis [001] in the plane orthogonal to the optical axis is rotated 45° relative to the fluorite lenses 105a and 105b. In the second lens group of this variation, it is possible to keep the birefringence amount substantially constant regardless of the directional angle from the optical axis AX101 by keeping the difference between the sum of the optical path lengths in the second A lens group (105am+105bm) and the optical path length in the second B lens group (106am) no greater than ±0.5×10⁻⁶×λ³ (cm) for a light beam 101m corresponding to 60-90% of the image-side NA.

On the other hand, the first lens group having the crystal axis [111] as the optical axis is composed of a first A lens group comprising a pair of fluorite lenses 109a and 109b, and a first B lens group comprising a single fluorite lens 110a. Here, the fluorite lenses 109a and 109b are such that the orientations of the crystal axes [−110] in the plane orthogonal to the optical axis are the same. Furthermore, in the fluorite lens 110a, the orientation of the crystal axis [−110] in the plane orthogonal to the optical axis is rotated 60° relative to the fluorite lenses 109a and 109b. In the first lens group of this variation, it is possible to keep the birefringence amount substantially constant regardless of the directional angle from the optical axis AX101 by keeping the difference between the sum of the optical path lengths in the first A lens group (109am+109bm) and the optical path length in the first B lens group (110am) no greater than ±0.5×10⁻⁶×λ³ (cm) for a light beam 102m corresponding to 60-90% of the image-side NA.

Furthermore, it is possible offset the birefringence that is substantially constant with respect to the directional angle from the optical axis AX101 and to substantially completely remove the effects of birefringence by setting the difference between 1.5 times the sum (105am+106am+105bm) of the optical path lengths in the second lens group having the crystal axis [100] as the optical axis, and the sum (109am+109bm+110am) of the optical path lengths in the first lens group having the crystal axis [111] as the optical axis, no greater than ±1.0×10⁻⁶×λ³ (cm).

In the above-described variation, the first B lens group and the second B lens group are each composed of a single fluorite lens. However, this is intended to be illustrative and not limiting, for it is also possible for the first B lens group and the second B lens group to each be composed of a plurality of fluorite lenses like the first A lens group and the second A lens group. Naturally, in this case also, the sum of the optical path lengths in the first B lens group and the sum of the optical path lengths in the second B lens group become the sum of the optical path lengths in the plurality of fluorite lenses.

In the above-described variation, the pair of fluorite lenses 105a and 105b along the optical path of the imaging light beam in the second A lens group are arranged so as to be relatively close to each other. In addition, the pair of fluorite lenses 109a and 109b along the optical path of the imaging light beam in the first A lens group are arranged so as to be close to each other. However, in general the first A lens group, the first B lens group, the second A lens group and the second B lens group are not limited to compositions such that the plurality of fluorite lenses are positioned close to each other.

The efficacy of the present invention can be realized even if, for example, a quartz lens made of quartz glass or a crystal lens made from a crystal material but having another crystal axis as the optical axis (hereinafter such a lens will be referred to as an “excluded lens”) is positioned between the fluorite lenses in each lens group. However, when the excluded lenses positioned in each lens group have a relatively high power (refractive power), the angle that exposure light beams make with the optical axis in each lens group (first A, first B, second A, second B) varies greatly because of the refractive action of these excluded lenses, creating the worry that the efficacy of the present invention in eliminating birefringence will be weakened. Consequently, it is preferable in the first A lens group, the first B lens group, the second A lens group and the second B lens group for the plurality of fluorite lenses to be positioned close to each other along the optical path of the image light beam.

Similarly, the first A lens group and the first B lens group compose the first lens group and eliminate birefringence through their mutual actions, and hence it is preferable for lenses having high powers to not be positioned between the first A lens group and the first B lens group. Moreover, it is preferable for the first A lens group and the first B lens group to be positioned close to each other along the optical path of the imaging light beam. The same is also true between the second A lens group and the second B lens group that comprise the second lens group.

Although there is no problem in the projection optical system of the first embodiment, when a lens having a high power is positioned between the first lens group and the second lens group, depending on the design type of the projection optical system, the birefringence offsetting effect between the first lens group and the second lens group could weaken. In such a projection optical system, it is preferable to not position a lens having a high power between the first lens group and the second lens group. Furthermore, it is preferable for the first lens group and the second lens group to be positioned close to each other along the optical path of the imaging light beam. In the above embodiment, the imaging light beams in each lens formed of crystals of fluorite and the like were all light beams that converged toward a photosensitive substrate (target exposure substrate) such as a wafer. In this case, it is preferable in the lens pair (first lens group) having the crystal axis [111 ] of the fluorite crystal as the optical axis for the crystal direction of both lenses to be mutually rotated 60° about the crystal axis [111] that is the optical axis, as was discussed in the above-described embodiment. However, when the light beam in a specific lens changes so as to diverge while going toward the photosensitive substrate 102 due to reasons such as a lens of high power being between the two or more lenses, the birefringence created by this lens will be different in rotational anisotropy from the birefringence created by other lenses.

That is to say, in the case of a divergent light beam, the angle with respect to the optical axis (crystal axis [111]) becomes opposite that of a convergent light beam. As shown in FIG. 5a, when the angle formed by the convergent light beam with the optical axis AX100 is positive and the light is incident from the right side with respect to the optical axis AX in FIG. 5a, the divergent light beam forms a negative angle with the optical axis AX100 and is incident from the left side with respect to the optical axis AX in FIG. 5a. At this time, the birefringence action received by the divergent light beam is the same as the action when a convergent light beam is incident on the lens rotated 60° about the optical axis (crystal axis [111]) shown in FIG. 5b. Accordingly, in the first lens group having the crystal axis [111] as the optical axis, for a lens pair in which an imaging light beam passing inside is convergent in one lens and divergent in the other, rotation by 60° about the optical axis is not necessary, for it is preferable for the same crystal axes to be oriented in the same direction in the plane orthogonal to the optical axis. On the other hand, in a lens pair (second lens group) having the crystal axis [100] of the fluorite crystal as the optical axis, the action of birefringence is the same for both convergent light beams and divergent light beams, and consequently even in lens pairs in which imaging light beams passing inside are convergent in one and divergent in the other, rotation by 45° about the optical axis is still preferable.

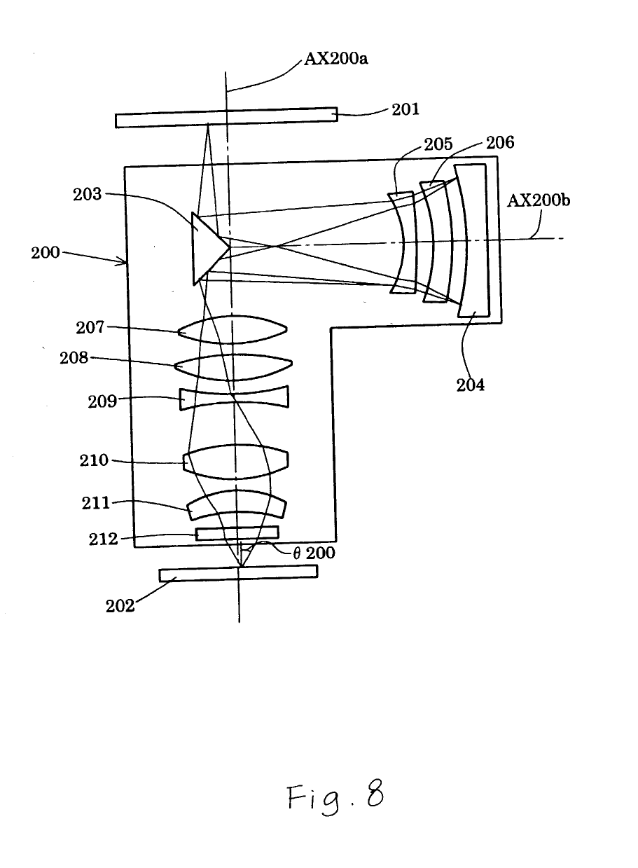

FIG. 8 is a drawing schematically showing the composition of a projection optical system according to a second embodiment of the present invention. In the second embodiment, the present invention is applied to a catadioptric type projection optical system in which aberration correction has been optimized for an F2 laser with a wavelength λ (nm) of 157 nm. In the projection optical system 200 of the second embodiment (which corresponds to the projection optical system 300 in FIG. 1), a light beam exiting from a point on the reticle 201 (which corresponds to the reticle 101 in FIG. 1) is deflected by a reflective prism 203 functioning as an optical path altering means, and is then incident on a concave reflective mirror 204 via lenses 205 and 206, which are arranged along the optical axis AX200b.

The light beam that is reflected by the concave reflective mirror 204 is again deflected by the reflective prism 203 via the lenses 206 and 205. The light beam that has been deflected by the reflective prism 203 is condensed on a wafer 202 (corresponding to the wafer 102 in FIG. 1) via lenses 207-212 that are arranged along the optical axis AX200a. In this manner, a projected image of the pattern etched in the reticle 201 is formed on the wafer 202. In the second embodiment, all of the lenses 205-212 are made of calcium fluoride crystals (fluorite).

In the projection optical system 200 of the second embodiment, the lens groups that cause the effects of birefringence of the fluorite to occur strikingly are lens groups such that the direction of progress of imaging light rays in the interior thereof form a large angle with respect to the optical axis AX200a or AX200b. As shown in FIG. 8, in the fluorite lenses 205 and 206 positioned close to the concave reflective mirror 204, and in the fluorite lenses 210, 211 and 212 positioned close to the wafer 202, the direction of progress of the image light beam forms a large angle with respect to the optical axes AX200a and AX200b. Because which lens causes the effects of birefringence to occur strikingly varies depending on the lens design, the lenses that cause the striking occurrence of the effects of birefringence are not always the above-described lenses.

In particular, in the catadioptric type projection optical system 200, the imaging light beam passes in both directions through the fluorite lenses 205 and 206 positioned close to the concave reflective mirror 204, and consequently the effects of birefringence in these fluorite lenses 205 and 206 are doubled. Hence, in the second embodiment, in the first lens group comprising the fluorite lenses 205 and 206, the crystal axis [111] is made to coincide with the optical axis AX200b (and hence with the optical axes of the fluorite lenses 205 and 206). Furthermore, the fluorite lenses 205 and 206 are arranged such that the crystal axes [−110] in the plane orthogonal to the optical axis are rotated 60° relative to each other about the optical axis. Accordingly, the fluorite lens 205 comprises the first A lens group and the fluorite lens 206 comprises the first B lens group.

On the other hand, in the second lens group composed of the fluorite lenses 210, 211 and 212, the crystal axes [100] are made to coincide with the optical axis AX200a. Of the three fluorite lenses 210-212, the fluorite lens 210, which is the thickest, comprises the second A lens group, while the other two fluorite lenses 211 and 212 comprise the second B lens group. That is to say, the fluorite lens 210 and the fluorite lenses 211 and 212 are arranged such that the crystal axes [001] in the plane orthogonal to the optical axis are rotated by 90° relative to each other about the optical axis.

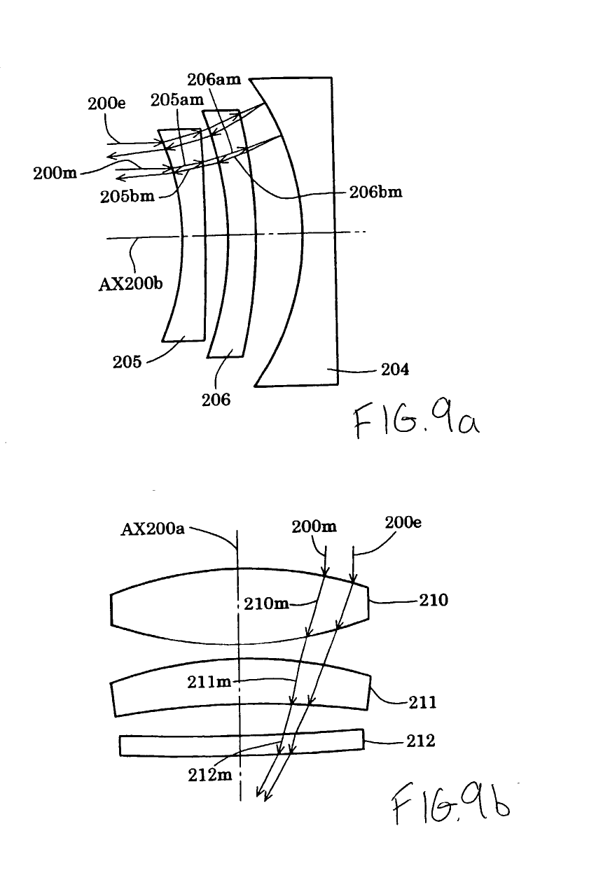

FIG. 9 (FIGS. 9a and 9b) explain the optical path in the fluorite lenses in the projection optical system according to the second embodiment. In FIG. 9, the light beam (the light beam corresponding to the image-side NA) incident on the wafer 202 at the maximum angle of incidence θ200 (see FIG. 8) is indicated by a reference number 200e. In the second embodiment, for the light beam 200m corresponding to 60-90% of the image-side NA, the difference between the sum of the optical path lengths (205am+205bm) in the first A lens group and the sum of the optical path lengths (206am+206bm) in the first B lens group is set so as to not be greater than ±0.5×10⁻⁶×λ³ (cm). In addition, for the light beam 200m corresponding to 60-90% of the image-side NA, the difference between the optical path length (210m) in the second A lens group and the sum of the optical path lengths (211m+212m) in the second B lens group is set so as to not be greater than ±0.5×10⁻⁶×λ³ (cm).

Moreover, for the light beam 200m corresponding to 60-90% of the imageside NA, the difference between the sum of the optical path lengths (205am+205bm+206am+206bm) in the first lens group having the crystal axis [111] as the optical axis and 1.5 times the sum of the optical path lengths (210m+211lm+212m) in the second lens group having the crystal axis [100] as the optical axis is set so as to not be greater than ±1.0×10⁻⁶×λ³ (cm). In this manner, it is possible in this second embodiment also to substantially completely remove the effects of birefringence through the combination of the first lens group and the second lens group, the same as in the first embodiment.

In the above-described second embodiment, all of the lenses 205-212 are made of fluorite, and consequently birefringence occurs in the other fluorite lenses 207-209 besides the first lens group (205, 206) and the second lens group (201, 211, 212). However, in the fluorite lenses 207-209, the angle formed by the direction of progress of an imaging light beam with respect to the optical axis is relatively small. Accordingly, it is possible to keep birefringence occurring in each of the fluorite lenses 207-209 to a minimum by having the optical axes of the fluorite lenses 207-209 coincide with the crystal axes [111] or [100], and hence it is possible to keep the effects of birefringence caused by the fluorite lenses 207-209 to a minimum.

However, when it is impossible to ignore the effects of birefringence caused by the fluorite lenses 207-209, a first lens group and second lens group may be composed from these fluorite lenses 207-209 (in actuality, four or more lenses are used), and the present invention may be applied to this first lens group and second lens group. That is to say, in the first lens group the optical axis are made to coincide with the crystal axis [111], and in the second lens group the optical axis are made to coincide with the crystal axis [100]. Furthermore, the first A lens group and first B lens group that together comprise the first lens group are set so that their crystal axis directions have a predetermined angular relationship about the optical axis, and the second A lens group and the second B lens group that together comprise the second lens group are set so that their crystal axis directions have a predetermined angular relationship about the optical axis. Furthermore, the optical path lengths in each of the lens groups (first A, first B, second A, second B) for a light beam corresponding to 60-90% of the image-side NA are set so as to satisfy a predetermined relationship, and through this it is possible to correct with even higher precision the effects of birefringence.

In the above-described first embodiment and second embodiment, the permissible value for the difference between the sum of the optical path lengths in the first A lens group and the sum of the optical path lengths in the first B lens group, and the permissible value for the difference between the sum of the optical path lengths in the second A lens group and the sum of the optical path lengths in the second B lens group, are set to ±0.5×10⁻⁶×λ³ (cm). The concrete numerical value of this permissible value is ±3.6 (cm) in the case of the first embodiment, that is to say the case of an ArF laser light source with a wavelength λ of 193 (nm). Furthermore, the concrete numerical value of this permissible value is ±1.9 (cm) in the case of the second embodiment, that is to say the case of an F2 laser light source with a wavelength λ of 157 (nm).

On the other hand, the permissible value for the difference between the sum of the optical path lengths in the first lens group and 1.5 times the sum of the optical path lengths in the second lens group is set to ±1.0×10⁻⁶×λ³ (cm). The concrete numerical value of this permissible value is ±7.2 (cm) in the case of the first embodiment, that is to say the case of an ArF laser light source with a wavelength λ of 193 (nm). Furthermore, the concrete numerical value of this permissible value is ±3.8 (cm) in the case of the second embodiment, that is to say the case of an F2 laser light source with a wavelength λ of 157 (nm). As described above, the reason the wavelength λ is raised to the third power in the equation showing the permissible value of the optical path length difference is because in the case of birefringence dependent on the direction of progress of light in the crystal material, the amount of fluctuation in the indices of refraction, that is to say the amount of difference in the wavefront of the imaging light beam (in units of length) is proportional to λ⁻², and hence the quantity that has a negative effect on the imaging characteristic is proportional to λ⁻³ as a wavefront aberration (phase).

The standard for the above-described optical path length difference is the permissible value in order to not have a large effect on the imaging characteristic when a fine pattern with a k1 factor of 0.35 is assumed (linewidth=k1×λ/NA, where λ is the exposure wavelength), and when the exposed pattern size is even smaller, it follows that a more strict standard is necessary. Here, the optical path length indicates the actual length of the optical path inside the crystal materials (the geometric length), and does not mean the value multiplied by the index of refraction or the value divided by the index of refraction.

In addition, in the first embodiment and second embodiment, the problem is the difference in the total optical path length in the crystal lenses between each lens group (first A, first B, second A, second B) and the difference in total optical path lengths in the crystal lenses between the first lens group and the second lens group, for a light beam corresponding to 60-90% of the image-side NA (maximum NA), that is to say a light beam that forms an angle corresponding to 0.6 to 0.9 times the image-side NA with respect to the optical axis. This is because the light beam corresponding to less than 70% of the image-side NA corresponds to approximately 50% of the image-side light beam as a whole, and because it is possible to eliminate birefringence with the best balance in the image-side light beam as a whole by making the birefringence elimination effect a maximum for light beams corresponding to around 70% of the image-side NA.

However, depending on the types of aberrations created by birefringence and the types of patterns that the projection optical system is supposed to expose, the aberration of the light beam in a closer position to the image-side NA could have a larger effect on the imaging characteristics. Accordingly, for a light beam with a broadened configuration on the maximum NA side centered about 70% of the image-side NA, that is to say a light beam corresponding to 60-90% of the image-side NA, it is preferable for the settings to be such that the birefringence elimination effect is a maximum.

Furthermore, in the above-described first embodiment and second embodiment, the explanation was focused on only an imaging light beam exiting from one point on the reticle 101 (201) in order to simplify the explanation of the present invention. However, in order to obtain good imaging performance, the above-described relationships of the present invention should naturally be satisfied for the imaging light beams reaching the effective exposure area on the wafer 102 (202) from all points within the effective illumination area on the reticle 101 (201).

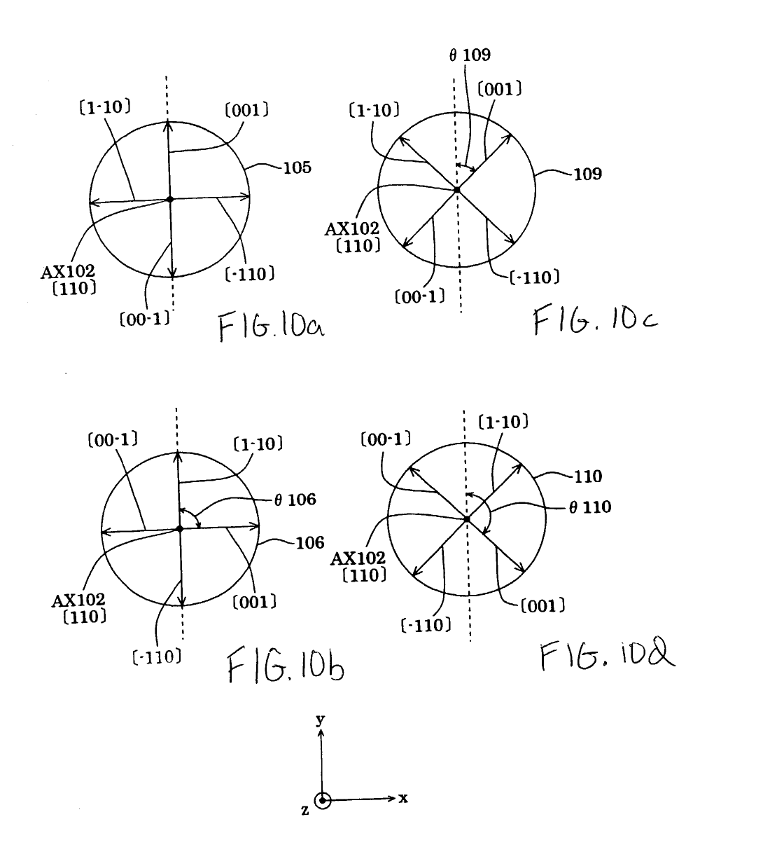

As a third embodiment of the present invention, there is also a method for eliminating the effects of birefringence by combining lens groups having the crystal axis [110] as the optical axis. FIG. 10 (FIGS. 10a and 10b) explain birefringence when the optical axis of the fluorite lens coincides with the crystal axis [110]. For example, when the third embodiment is applied to the projection optical of the first embodiment, the optical axes of the fluorite lenses 105 and 106 both coincide with the crystal axis [110], as shown in FIGS. 10a and 10b.

The fluorite lenses 105 and 106 are arranged such that the crystal axes [001] lying in a plane orthogonal to the optical axis AX102 are rotated 90° relative to each other about the optical axis. In other words, the fluorite lens 106 is such that the orientation of the crystal axis [001] is rotated about the −Z axis by an angle θ106=90° with the fluorite lens 105 as a reference. In this manner, the fluorite lens 105 comprises a third A lens group, the fluorite lens 106 comprises a third B lens group and the fluorite lenses 105 and 106 together comprise a third lens group.

In a combination that makes the crystal axis [110] the optical axis, it is possible to keep the birefringence (the difference in indices of refraction between the R-polarized light and the θ-polarized light) smaller than in a combination that makes the crystal axis [111] the optical axis or a combination that makes the crystal axis [100] the optical axis. However, in a combination that makes the crystal axis [110] the optical axis, the uniformity of birefringence with respect to a directional angle centered about the optical axis is poor, and nonuniformity with a 90° period remains.

Hence, in the third embodiment, the optical axes of both fluorite lenses 109 and 110 are made to coincide with the crystal axes [110], as shown in FIGS. 10c and 10d. Furthermore, the fluorite lenses 109 and 110 are arranged such that the crystal axes [001] lying in a plane orthogonal to the optical axis AX102 are rotated 90° relative to each other about the optical axis. Moreover, the fluorite lenses 105 and 106 and the fluorite lenses 109 and 110 are set so as to have a positional relationship rotated 45° relative to each other about the optical axis AX102.

That is to say, the fluorite lens 106 is such that the orientation of the crystal axis [001] is rotated about the −Z axis by an angle θ106=90°, the fluorite lens 109 is such that the orientation of the crystal axis [001] is rotated about the −Z axis by an angle θ109=45°, and the fluorite lens 110 is such that the orientation of the crystal axis [001] is rotated about the −Z axis by an angle θ110=135°, with the fluorite lens 105 as a reference. In this manner, the fluorite lens 109 comprises a fourth A lens group, the fluorite lens 110 comprises a fourth B lens group and the fluorite lenses 109 and 110 together comprise a fourth lens group.

As noted above, in the third embodiment by arranging the pair of lens pairs having nonuniformity with a 90° period, that is to say the third lens group and the fourth lens group, so that they are rotated 45° relative to each other, the nonuniformity with a 90° period is substantially completely eliminated. In addition, as discussed above, the residual birefringence resulting from positioning the crystal axes [110] to be rotated by 90° about the optical axis relative to each other is small, and consequently, by rotating the pair that has been rotated 90° an additional 45°, it is possible to obtain adequate birefringence elimination.

In this third embodiment also, the third lens group and fourth lens group comprising a pair rotated 90° are not limited to a composition made of two fluorite lenses, for it is possible for these lens groups to be made of three or more fluorite lenses. Moreover, for a light beam corresponding to 60-90% of the image-side NA, in addition to setting the difference between the optical path length of the third A lens group and the optical path lengths of the third B lens group to not be greater than ±0.5×10⁻⁶×λ³ (cm), it is preferable for the difference between the optical path length of the fourth A lens group and the optical path lengths of the fourth B lens group to be set so as to not be greater than ±0.5×10⁻⁶×λ³ (cm). Furthermore, for a light beam corresponding to 60-90% of the image-side NA, it is preferable for the difference between the sum of the optical path lengths in the third lens group and the sum of the optical path lengths in the fourth lens group to be set so as to not be greater than ±1.0×10⁻⁶×λ³ (cm).

In the foregoing third embodiment, out of the lenses having the crystal axis [110] as the optical axis, the two fluorite lenses belonging to the third lens group (lens 105 and lens 106) positioned close to each other, and the two fluorite lenses belonging to the fourth lens group (lens 109 and lens 110) positioned close to each other, are positioned in each lens group such that the crystal axes [001] lying in a plane orthogonal to the optical axis are rotated by 90° about the optical axis. In addition, the third lens group and the fourth lens group are arranged so as to be rotated 90° about the optical axis relative to each other. However, in the lens group having the crystal axis [110] as the optical axis, that is to say in the [110] lens group, the relationship among the rotational angles about the optical axis of each lens is not limited to this.

That is to say, for the four lenses—fluorite lens 105, fluorite lens 106, fluorite lens 109 and fluorite lens 110—it is possible to obtain the equivalent birefringence elimination effect as in the third embodiment by setting the relationship among the rotational angles of the lenses so that the crystal axes [001] lying in a plane orthogonal to the optical axis lie separated by 45° each about the optical axis. In this case, among the four fluorite lenses, the second lens has a positional relationship rotated by 45° to a predetermined orientation about the optical axis with respect to the first lens, the second lens has a positional relationship rotated by 45° to the same a predetermined orientation about the optical axis with respect to the third lens, and the third lens has a positional relationship rotated by 45° to the same predetermined orientation about the optical axis with respect to the fourth lens.

In addition, that the fluorite lens 105, fluorite lens 106, fluorite lens 109 and fluorite lens 110 may each be composed of a plurality of fluorite lenses is the same as in the other embodiments discussed above. In this case, each of the at least four fluorite lenses are separated into one of four lens groups, that is to say a sixth lens group, a seventh lens group, an eighth lens group and a ninth lens group, in which the crystal axes [001] lying in a plane orthogonal to the optical axis coincide with predetermined directions separated by 45° each about the optical axis, and are arranged rotated by a predetermined angle about the optical axis.

Furthermore, for a light beam corresponding to 60-90% of the image-side NA, the sum L6 of the optical path lengths in the sixth lens group, the sum L7 of the optical path lengths in the seventh lens group, the sum L8 of the optical path lengths in the eighth lens group and the sum L9 of the optical path lengths in the ninth lens group are set so as to be substantially equal to each other. Specifically, out of the sum L6 of the optical path lengths in the sixth lens group, the sum L7 of the optical path lengths in the seventh lens group, the sum L8 of the optical path lengths in the eighth lens group and the sum L9 of the optical path lengths in the ninth lens group, the difference between any two arbitrarily selected sums of optical path lengths is set so as to not be greater than ±0.5×10⁻⁶×λ³ (cm). In his manner, the effects of birefringence can be kept small the same as in the third embodiment.

As discussed above, with the [110] lens group having the crystal axis [110] as the optical axis with lenses arranged so as to be rotated relative to each other about the optical axis, it is possible to keep the effects of birefringence smaller than with the [111] lens group having the crystal axis [111] as the optical axis with lenses rotated 60° relative to each other about the optical axis or with the [100] lens group having the crystal axis [100] as the optical axis with lenses rotated 45° relative to each other about the optical axis. In addition, in the birefringence that remains in the [110] lens group, it became clear from the inventors' analysis that the index of refraction (nR110) for the above-described R-polarized light is higher than the index of refraction (nθ110) for the above-described θ-polarized light.

That is to say, the sign of the birefringence surviving in the [110] lens group is the same sign as the birefringence surviving in the [111] lens group, and the opposite sign from the birefringence surviving in the [100] lens group. Accordingly, it is possible to offset the effects of birefringence by using a combination of the [110] lens group and the [100] lens group. Furthermore, it is possible to offset the effects of birefringence by using a combination of the [110] lens group, the [100] lens group and the [111] lens group.

To be more precise, it has become clear from the inventors' analysis that the relationship expressed in the following equation (1) is satisfied among the difference between the index of refraction nR110 for R-polarized light and the index of refraction nθ110 for θ-polarized light in the [110] lens group, the difference between the index of refraction nR100 for R-polarized light and the index of refraction nθ100 for θ-polarized light in the [100] lens group and the difference between the index of refraction nR111 for R-polarized light and the index of refraction nθ100 for θ-polarized light in the [ 111 ] lens group.

(nR110-nθ110):(nR100-nθ100):(nR111-nθ111 )=3:−12:8 (1)

In the above equation (1), focusing on the difference between the index of refraction nR100 and the index of refraction nθ100, and the difference between the index of refraction nR111 and the index of refraction nθ111, the relationship expressed by the equation (2) below can be obtained. This equation (2) is consistent with the statement in the first embodiment to the effect that “the birefringence of the lens pair (105, 106) having the crystal axis [100] as the optical axis, that is to say (nR100-nθ100), is approximately −1.5 times the birefringence of the lens pair (109, 110) having the crystal axis [111] as the optical axis, that is to say (nR111-nθ111).”

(nR100-nθ100):(nR111-nθ111)=−12:8 (2)

Accordingly, in an optical system containing a plurality of lenses (optical elements) formed of a crystal belonging to a cubic system, for a light beam corresponding to 60-90% of the image-side NA, for example, it is possible to keep the effects of birefringence to a minimum when the relationship expressed in the equation (3) below is satisfied between the sum L110 of the optical path lengths in the [110] lens group, the sum L100 of the optical path lengths in the [100] lens group and the sum L111 of the optical path lengths in the [111] lens group.

3×L110−12×L100+8×L111=0 (3)

Naturally, however, the lens groups having each crystal axis as the optical axis (the [110] lens group, [100] lens group and [111] lens group) may each be made up of lens groups having the desired rotational angle relationship and desired optical path length relationship, as discussed above. In reality, it is difficult to set the value on the left hand side of the equation (3) strictly to 0, but it is possible to effectively avoid the effects of birefringence by setting the value on the left hand side of the equation (3) to no greater than ±8.0×10⁻⁶×λ³ (cm). The permissible value for the left hand side of the equation (3) is the permissible value when exposure of a fine pattern with a k1 factor of 0.35 is assumed, the same as the permissible value discussed above. Accordingly, when a finer pattern is exposed it is necessary to set a stricter permissible value, and when a pattern that is not as fine is exposed, a less strict permissible value is adequate.

The equation (3) is not necessarily limited to the relationship between each optical path length when the [110] lens group and the [100] lens group and the [111] lens group are included. For example, in order to mitigate the effects of birefringence in an optical system in which the [111] lens group is not included and only the [110] lens group and [100] lens group are included, the relationship expressed by the equation (4) below should be satisfied between the sum L110 of the optical path lengths in the [110] lens group and the sum L100 of the optical path lengths in the [100] lens group.

3×L110−12×L100=0 (4)

Similarly, in an optical system in which the [110] lens group is not included and only the [111] lens group and [100] lens group are included, the relationship expressed by the equation (5) below should be satisfied between the sum L111 of the optical path lengths in the [111] lens group and the sum L100 of the optical path lengths in the [100] lens group.

12×L100−8×L111=0 (5)

In these equations (4) and (5) also, it is difficult to set the value on the left hand side strictly equal to 0, but by setting the value on the lefthand side in equation (4) and the value on the lefthand side in equation (5) to no greater than ±8.0×10⁻⁶×λ³ (cm), it is possible to effectively avoid the effects of birefringence. On the basis of this permissible value, it is possible to transform equation (5) as shown in equation (6), and to transform equation (6) as shown in equation (7).

|12×L100−8×L111|≦8.0×10⁻⁶×λ³ (6)

|1.5×L100−L111|≦1.0×10⁻⁶×λ³ (7)

Similarly, on the basis of this permissible value, it is possible to transform equation (4) as shown in equation (8), and to transform equation (8) as shown in equation (9).

|3×L110−12×L100|≦8.0×10⁻⁶×λ³ (8)

|L110−4×L100|≦2.7×10⁻⁶×λ³ (9)

Equation (7) is consistent with the statement in the first embodiment to the effect that “the difference between 1.5 times the sum (105m+106m) of the optical path lengths in the second lens group (105, 106) having the crystal axis [100] as the optical axis and the sum (109m+110m) of the optical path lengths in the first lens group (109, 110) having the crystal axis [111] as the optical axis is set so as to not be greater than ±1.0×10⁻⁶×λ³ (cm).” In addition, equation (9) means that it is possible to obtain a good imaging characteristic if the difference between the sum L110 of the optical path lengths in the [110] lens group and four times the sum L100 of the optical path lengths in the [100] lens group is not greater than ±2.7×10⁻⁶×λ³.

Depending on the design of the optical system, it is possible for there to be a plurality of lenses whose crystal axes [110] should coincide with the optical axis. In this case, the lenses whose crystal axes [110] should coincide with the optical axis may be divided into the above-described four lens groups (the sixth through ninth lens groups), and each lens may be rotated about the optical axis so that between each lens group, the crystal axes [001] lying in a plane orthogonal to the optical axis are each separated by 45° about the optical axis.

Alternatively, the lenses whose crystal axes [110] should coincide with the optical axis can be divided into eight lens groups. That it to say, two sets of the above-described four lens groups (the sixth through ninth lens groups) are created, and in the four lens groups of each of these sets, each lens is rotated about the optical axis so that the crystal axes [001] lying in a plane orthogonal to the optical axis are each separated by 45° about the optical axis. In this case, the rotational anisotropy of the birefringence is kept to a minimum in the four lens groups in each set, and consequently, there are no particular restrictions on the relationship of the crystal direction (the direction of the crystal axis [100] lying in a plane orthogonal to the optical axis) between the four lens groups of the first set and the four lens groups of the second set.

This kind of division of the lens groups is not limited to the above-described four groups or eight groups, for the four lens groups comprising the [110] lens groups may be divided into an arbitrary number of sets, which is to say that the lenses may be divided into groups the number of which is an integer multiple of 4 (4, 8, 12, and so forth). In this case, in the four lens groups of each of these sets, each lens is rotated about the optical axis so that the crystal axes [001] lying in a plane orthogonal to the optical axis are each separated by 45° about the optical axis. Furthermore, for a light beam corresponding to 60-90% of the image-side NA, for example, the lenses may be set so that the sum of the optical path lengths in each lens group in which the crystal axes [001] are facing the same direction are substantially equal to each other. Moreover, it is possible to effectively eliminate the negative effects of birefringence by having the sum L110 of the optical path lengths within the [110] lens groups of the plurality of sets satisfy the above-described relationship equations (3), (4) and (5).

In addition, the possibility also exists that there are a plurality of lenses whose crystal axes [100] should coincide with the optical axis, and in this case, it is possible to form a plurality of sets of [100] lens groups. In this case also, the rotational relationship of the crystal axis direction in each lens is set to 45° in the [100] lens group in each set, but there are no particular restrictions on the relationship of the crystal axis direction between the [100] lens groups of differing sets. Furthermore, it is possible to effectively eliminate the negative effects of birefringence by having the sum L100 of the optical path lengths within the [100] lens groups of the plurality of sets satisfy the above-described relationship equations (3), (4) and (5).

In addition, when there are a plurality of lenses whose crystal axes [111] should coincide with the optical axis, it is similarly possible to form a plurality of sets of [111] lens groups. In this case also, the rotational relationship of the crystal axis direction in each lens is set to 60° in the [111] lens group in each set, but there are no particular restrictions on the relationship of the crystal axis direction between the [111] lens groups of differing sets. Furthermore, it is possible to effectively eliminate the negative effects of birefringence by having the sum L111 of the optical path lengths within the [111] lens groups of the plurality of sets satisfy the above-described relationship equations (3), (4) and (5).

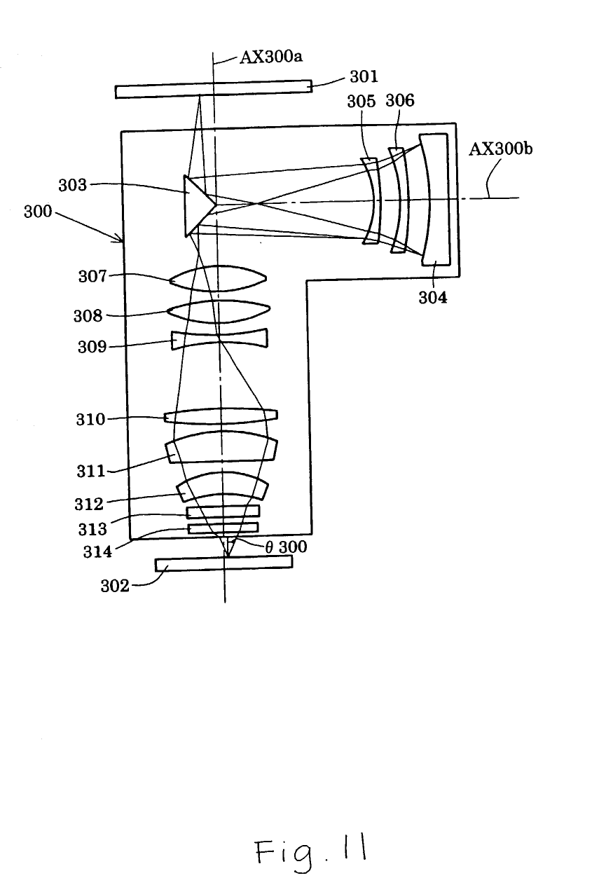

FIG. 11 is a diagram schematically showing the composition of a projection optical system according to a fourth embodiment of the present invention. In this fourth embodiment, the present invention is applied to a catadioptric projection optical system in which aberration correction has been optimized with respect to an F2 laser having a wavelength λ (nm) of 157 nm, the same as in the second embodiment. In the projection optical system 300 of the fourth embodiment, a light beam exiting from a point on the reticle 301 (which corresponds to the reticle 101 in FIG. 1) is deflected by a reflective prism 303 functioning as an optical path altering means, and is then incident on a concave reflective mirror 304 via lenses 305 and 306, which are arranged along the optical axis AX300b.

The light beam that is reflected by the concave reflective mirror 304 is again deflected by the reflective prism 303 via the lenses 306 and 305. The light beam that has been deflected by the reflective prism 303 is condensed on a wafer 302 (corresponding to the wafer 102 in FIG. 1) via lenses 307-314 that are arranged along the optical axis AX300a. In this manner, a projected image of the pattern etched in the reticle 301 is formed on the wafer 302. In the fourth embodiment, all of the lenses are made of calcium fluoride crystals (fluorite).

More precisely, in the fourth embodiment, in the fluorite lenses 305 and 306 the crystal axes [110] are made to coincide with the optical axis AX300b. In addition, in the fluorite lenses 311 and 312, the crystal axes [110] are made to coincide with the optical axis AX300a. Furthermore, in the fluorite lenses 313 and 314, the crystal axes [100] are made to coincide with the optical axis AX300a. In other words, the fluorite lenses 305, 306, 311 and 312 comprise a [110] lens group, and the fluorite lenses 313 and 314 comprise a [100] lens group.

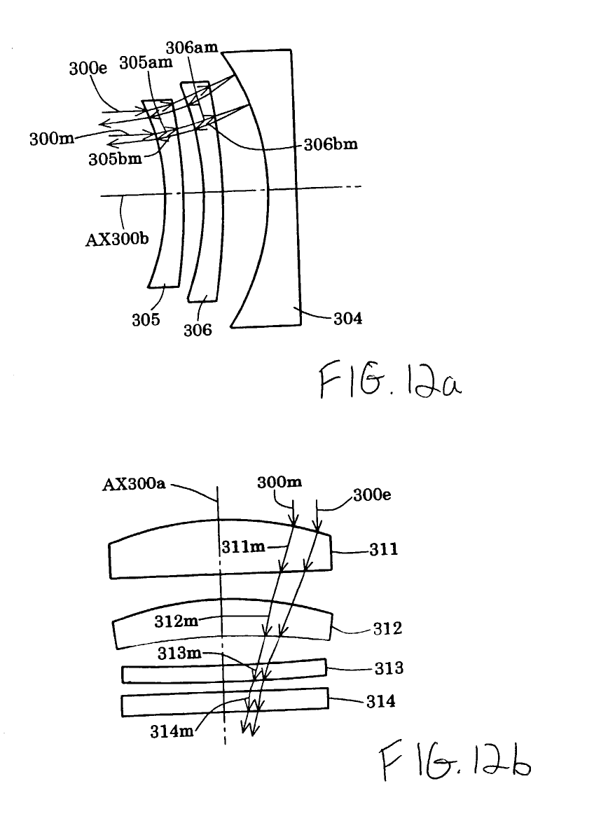

FIG. 12 (FIGS. 12a and 12b) explain the optical path in the fluorite lenses in the projection optical system according to the fourth embodiment. In FIG. 12, the light beam (the light beam corresponding to the image-side NA) incident on the wafer 302 at the maximum angle of incidence θ300 (see FIG. 11) is indicated by a reference number 300e. In addition, the light beam corresponding to 60-90% of the image-side NA is indicated by a reference number 300m. As shown in FIG. 12a, the imaging light beam passes through the two fluorite lenses 305 and 306 in both directions. Accordingly, for the light beam 300m corresponding to 60-90% of the image-side NA, the optical path length inside the fluorite lens 305 is (305am+305bm), and the optical path length inside the fluorite lens 306 is (306am+306bm).

On the other hand, as shown in FIG. 12b, for the light beam 300m corresponding to 60-90% of the image-side NA, the optical path length inside the fluorite lens 311 is 311m, the optical path length inside the fluorite lens 312 is 312m, the optical path length inside the fluorite lens 313 is 313m and the optical path length inside the fluorite lens 314 is 314m. In the fourth embodiment, the thickness and such of each lens is set so that each of the optical path lengths (305am+305bm, 306am+306 bm, 311m and 312m) in the fluorite lenses 305, 306, 311 and 312 with crystal axes [110] as the optical axis are all substantially equal and in the range of ±0.5×10⁻⁶×λ³ (cm).

In other words, the thickness and such of each lens is set so that the difference between any two arbitrarily selected optical path lengths, out of the optical path lengths (305am+305bm, 306am+306 bm, 311m and 312m) in the fluorite lenses 305, 306, 311 and 312, is not greater than ±0.5×10⁻⁶×λ³ (cm). In addition, in the fluorite lenses 305, 306, 311 and 312, the relationship of the rotational angle of each lens is set so that the crystal axes [100] lying in a plane orthogonal to either of the optical axes (AX300a, AX300b) are separated by 45° from each other about the optical axis.

In addition, for the fluorite lenses 313 and 314 with crystal axes [100] as the optical axes, the thickness and such of each lens is set so that the optical path lengths (313m and 314m) are substantially equal and in the range of ±0.5×10⁻⁶×λ³ (cm). In other words, the thickness and such of each lens is set so that the difference between the optical path length 313m in the fluorite lens 313 and the optical path length 314m in the fluorite lens 314 is not greater than ±0.5×10^{-6×λ}³ (cm). In addition, the fluorite lenses 313 and 314 are set so that the crystal axes [001] lying in a plane orthogonal to the optical axis AX300a have a positional relationship rotation by 45° relative to each other.

In this manner, in the fourth embodiment it is possible to offset the effects of birefringence and obtain good imaging characteristics between the [110] lens group comprising four lenses having the crystal axes [110] as the optical axis, and the [100] lens group comprising two lenses having the crystal axes [100] as the optical axis. Furthermore, it is possible to achieve the maximum from the above-described offset effects and to keep the effects of birefringence to a minimum by setting the lenses so that the sum (305am+305bm+306am+306bm+311m+312m=L110) of the optical path lengths in each of the fluorite lenses 305, 306, 311 and 312 in the [110] lens group, and the sum (313m+314m=L100) of the optical path lengths in each of the fluorite lenses 313 and 314 in the [100] lens group satisfy the above-described relationship equation (8) or (9).

That is to say, it is possible to achieve the maximum from the above-described offset effects and to keep the effects of birefringence to a minimum by setting the lenses so that between the sum L110 of the optical path lengths in the [110] lens group and the sum L100 of the optical path lengths in the [100] lens group, the absolute value of (3×L110−12×L100) is not greater than 8.0×10⁻⁶×λ³ (cm), or the absolute value of (L110−4×L100) is not greater than 2.7×10⁻⁶×λ³ (cm). In this fourth embodiment also, it is possible to further stimulate the birefringence elimination effect by setting the other fluorite lenses (lenses 307-310) in an arrangement that further eliminates birefringence.

In each of the above embodiments, for the [111] lens group in which the optical axis coincides with the crystal axes [111], the lenses are arranged rotated 60° about the optical axis between the plurality of lenses in order to eliminate birefringence. However, in the [111] lens group, the crystal direction has three-fold rotational symmetry about the optical axis (rotational symmetry with a period of 120°), and consequently, the above-described 60° rotation may also be a rotation of 60+120=180° or a rotation of 60+240=300°.

Similarly, in the [100] lens group in which the optical axis coincides with the crystal axes [100], the lens rotation angle to eliminate birefringence is 45° about the optical axis. However, in the [100] lens group, the crystal direction has four-fold rotational symmetry about the optical axis (rotational symmetry with a period of 90°), and consequently, the above-described 45° rotation may also be a rotation of 45+90=135°, 45+180=225°, or 45+270=315°.

In each of the embodiments discussed above, calcium fluoride crystals (fluorite) are used as the optical material with birefringence, but this is intended to be illustrative and not limiting, for it is also possible to use other single-axis crystals, for example barium fluoride crystals (BaF2), lithium fluoride crystals (LiF), sodium fluoride crystals (NaF), strontium fluoride crystals (SrF2), beryllium fluoride crystals (BeF2) or the like, or other crystal materials that are transparent with respect to ultraviolet rays. Of these, barium fluoride crystals are promising as a lens material because a large-scale crystal material exceeding 200 mm in diameter has already been developed. In this case, it is preferable for the crystal axis direction of barium fluoride (BaF2) or the like to be set in accordance with the present invention. In addition, in each of the embodiments discussed above, the present invention is applied to a projection optical system, but this is intended to be illustrative and not limiting, for it is also possible to apply the present invention to an illumination optical system that illuminates a reticle (mask).

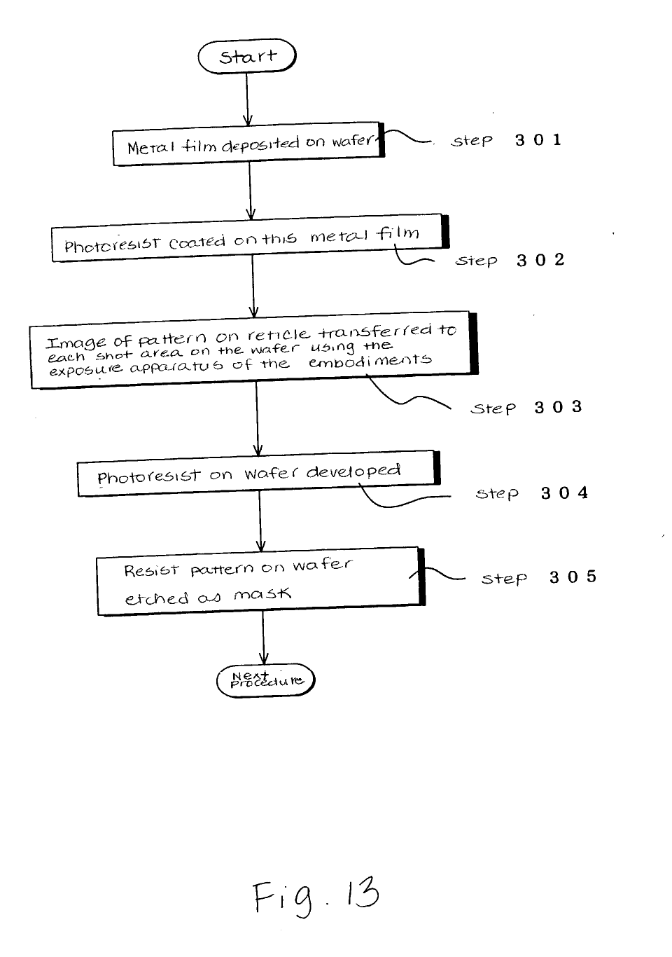

In the exposure apparatus of each of the above-described embodiments, it is possible to manufacture a microdevice (semiconductor device, imaging device, liquid crystal display device, thin film magnetic head, or the like) by illuminating a reticle (mask) with the illumination apparatus (illumination process), and using the projection optical system to expose a photosensitive substrate with a transfer pattern formed on the mask (exposure process). Below, one example is explained of a method used to obtain a semiconductor device as a microdevice by forming a predetermined circuit pattern on a wafer or the like serving as a photosensitive substrate using the exposure apparatus of each of the embodiments, with reference to the flowchart in FIG. 13.

First, in step S301 in FIG. 13, a metal film is deposited onto one lot of wafers. In the subsequent step S302, a photoresist is coated on the metal film on this lot of wafers. Following this, in step S303, an image of the pattern on the mask is successively transferred and exposed in each shot area on the lot of wafers via the projection optical system, using the exposure apparatus of each embodiment. Following this, in step S304, the photoresist on the lot of wafers is developed, after which in step S305 a circuit pattern corresponding to the pattern on the mask is formed on each shot are of each wafer by etching the resist pattern as a mask on the wafer lot.

After this, a device such as a semiconductor device or the like is fabricated by further accomplishing formation of the circuit patterns of the upper layers. Through the above-described semiconductor device fabrication method, it is possible to obtain good throughput of semiconductor devices having extremely fine circuit patterns. In steps S301 through S305, metal is deposited on the wafer, the metal film is coated with resist, and the various processes of exposure, developing and etching are accomplished, but naturally it would also be fine to form a silicon oxide film on the wafer in advance of these processes, to coat this silicon oxide film with resist and then accomplish the various procedures of exposure, developing and etching.

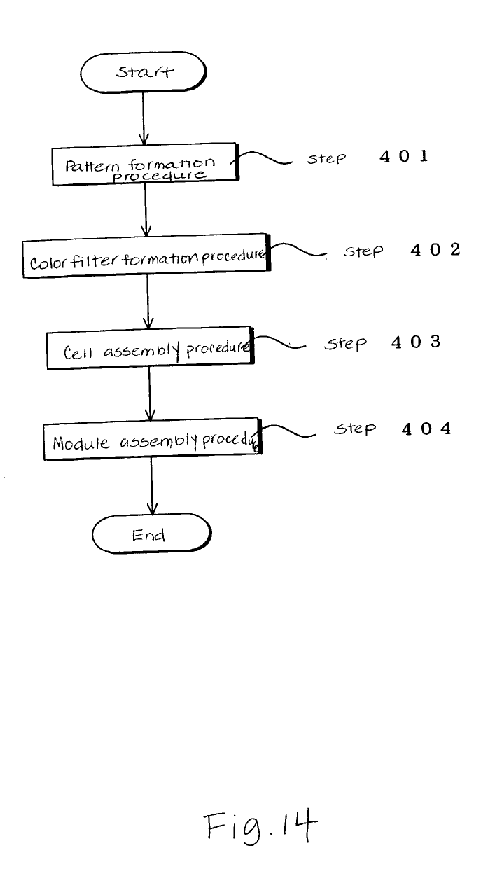

In addition, with the exposure apparatus of each of the embodiments, it is also possible to obtain a liquid crystal display device as a microdevice by forming a predetermined pattern (circuit pattern, electrode pattern or the like) on a plate (glass substrate). Below, one example of such a method is explained, with reference to the flowchart in FIG. 14. In FIG. 14, in pattern formation procedure 401, a so-called optical lithography procedure is accomplished in which the mask pattern is transferred and exposed onto a photosensitive substrate (a glass substrate or the like coated with resist) using the exposure apparatus of each of the embodiments. Through this optical lithography procedure, a predetermined pattern containing multiple electrodes or the like is formed on the photosensitive substrate. Following this, the predetermined pattern is formed on the substrate through various procedures by having the exposed substrate undergo a developing process, an etching process, a reticle removal process and the like, after which the color filter formation procedure 402 is accomplished.

Next, in the color filter formation procedure 402, a color filter is formed in which a plurality of groups of three dots corresponding to R (red), G (green) and B (blue) are arrayed in a matrix shape, or a plurality of groups of filters of R, G and B stripes are arrayed in a horizontal scanning line direction. Furthermore, after the color filter formation procedure 402, a cell assembly procedure 403 is accomplished. In the cell assembly procedure 403, a liquid crystal panel (liquid crystal cell) is assembled using the substrate having the predetermined pattern obtained in the pattern formation procedure 401 and the color filter obtained in the color filter formation procedure 402. In the cell assembly procedure 403, a liquid crystal panel (liquid crystal cell) is produced by injecting a liquid crystal, for example, between the substrate having the predetermined pattern obtained in the pattern formation procedure 401, and the color filter obtained in the color filter formation procedure 402.

Following this, in the module assembly procedure 404, the liquid crystal display device is finished by attaching various parts including a backlight and electric circuits that cause the display action of the assembled liquid crystal panel (liquid crystal cell). Through the above-described liquid crystal display device production method, it is possible to obtain good throughput of liquid crystal display devices having extremely fine circuit patterns.

In each of the above-described embodiments, the present invention is applied to a projection optical system mounted in an exposure apparatus, but this is intended to be illustrative and not limiting, for the present invention may also be applied to other general optical systems, including optical systems for scanning this projection optical system, for example an aberration-measuring optical system. In addition, in each of the above-described embodiment, an ArF excimer laser light source that supplies light with a wavelength of 193 nm or an F2 laser light source that supplies light with a wavelength of 157 nm were used, but this is intended to be illustrative and not limiting, for it would also be possible to use, for example, an Ar laser light source supplying light with a wavelength of 126 nm.

As explained above, with the present invention, it is possible to realize an optical system having good optical performance in effect without receiving the effects of birefringence even when using a birefringent crystal material such as fluorite, for example. Accordingly, by incorporating the optical system of the present invention into an exposure apparatus, it is possible to fabricate good microdevices through high precision projection exposure via a high resolution projection optical system.

While the invention has been described with reference to preferred embodiments thereof, it is to be understood that the invention is not limited to the preferred embodiments or constructions. To the contrary, the invention is intended to cover various modifications and equivalent arrangements conceived by those skilled in lithographic systems. In addition, while the various elements of the preferred embodiments are shown in various combinations and configurations, which are exemplary, other combinations and configurations, including more, less or only a single element, are also within the spirit and scope of the invention.

What is claimed is:

1. An optical system that includes a plurality of optical elements formed of a crystal belonging to a cubic system, comprising:
a first element group composed of a plurality of optical elements arranged such that the optical axis of the optical system substantially coincides with a crystal axis [111 ] of the system or a crystal axis optically equivalent to the crystal axis; and
a second element group composed of a plurality of optical elements arranged such that the optical axis substantially coincides with a crystal axis [100] or a crystal axis optically equivalent to the crystal axis; and wherein
the first element group has a first A element group and a first B element group having a positional relationship rotated relative to each other by a first angle about the optical axis; and
the second element group has a second A element group and a second B element group having a positional relationship rotated relative to each other by a second angle about the optical axis;
the optical path length L1A, of light beams forming an angle of predetermined range with respect to the optical axis, in the optical elements in the first A element group, and the optical path length L1B of the light beams in the optical elements in the first B element group are substantially equal;
the optical path length L2A, of light beams forming an angle of predetermined range with respect to the optical axis, in the optical elements in the second A element group, and the optical path length L2B of the light beams in the optical elements in the second B element group are substantially equal; and
the optical path length L1 (=L1A+L1B), of light beams having an angle of the predetermined range with respect to the optical axis, in the optical elements in the first element group and the optical path length L2 (=L2A+L2B) of the light beams in the optical elements in the second element group are set in accordance with a predetermined magnification.

2. The optical system according to claim 1, wherein the optical path length L1 in the optical elements in the first element group is set to approximately 1.5 times the optical path length L2 in the optical elements in the second element group.

3. The optical system according to claim 2, wherein the difference between 1.5 times the optical path length L2 in the optical elements in the second element group and the optical path length L1 in the optical elements in the first element group is set so as to not be greater than ±1.0×10⁻⁶×λ³ (cm), where λ (nm) is the wavelength of the light beam.

4. The optical system according to claim 1, wherein the difference between the optical path length L1A in the optical elements in the first A element group and the optical path length L1B in the optical elements in the first B element group is set so as to not be greater than ±0.5×10⁻⁶×λ³ (cm), where λ (nm) is the wavelength of the light beam.

5. The optical system according to claim 1, wherein the difference between the optical path length L2A in the optical elements in the second A element group and the optical path length L2B in the optical elements in the second B element group is set so as to not be greater than ±0.5×10⁻⁶×λ³ (cm), where λ (nm) is the wavelength of the light beam.

6. The optical system according to claim 1, wherein the angle within the predetermined range is larger than an angle corresponding to 0.6 times the image-side numerical aperture of the optical system while being smaller than an angle corresponding to 0.9 times the image-side numerical aperture.

7. An optical system that includes a plurality of optical elements formed of crystals belonging to a cubic system, comprising:
a third element group and a fourth element group each composed of a plurality of optical elements set up such that the optical axis of the optical system substantially coincides with a crystal axis [110] of the system or a crystal axis optically equivalent to the crystal axis; and wherein
the third element group has a third A element group and a third B element group having a positional relationship rotated relative to each other by a third angle about the optical axis; and
the fourth element group has a fourth A element group and a fourth B element group having a positional relationship rotated relative to each other by a fourth angle about the optical axis;
the third element group and the fourth element group have a positional relationship rotated relative to each other by a fifth angle about the optical axis;
the optical path length L3A, of light beams having an angle of predetermined range with respect to the optical axis, in the optical elements in the third A element group, and the optical path length L3B of the light beams in the optical elements in the third B element group are substantially equal;
the optical path length L4A, of light beams having an angle of the predetermined range with respect to the optical axis, in the optical elements in the fourth A element group, and the optical path length L4B of the light beams in the optical elements in the fourth B element group are substantially equal; and
the optical path length L3 (=L3A+L3B), of light beams having an angle of the predetermined range with respect to the optical axis, in the optical elements in the third element group and the optical path length L4 (=L4A+L4B) of the light beams in the optical elements in the fourth element group are set in accordance with a predetermined magnification.

8. The optical system according to claim 7, wherein the optical path length L3 in the optical elements in the third element group and the optical path length L4 in the optical elements in the fourth element group are set substantially equal to each other.

9. The optical system according to claim 8, wherein the difference between the optical path length L3 in the optical elements in the third element group and the optical path length L4 in the optical elements in the fourth element group is set so as to not be greater than ±1.0×10⁻⁶λ³ (cm), where λ (nm) is the wavelength of the light beam.

10. The optical system according to claim 7, wherein the difference between the optical path length L3A in the optical elements in the third A element group and the optical path length L3B in the optical elements in the third B element group is set so as to not be greater than ±0.5×10⁻⁶×λ³ (cm), where λ (nm) is the wavelength of the light beam.

11. The optical system according to claim 7, wherein the difference between the optical path length L4A in the optical elements in the fourth A element group and the optical path length L4B in the optical elements in the fourth B element group is set so as to not be greater than ±0.5×10⁻⁶×λ³ (cm), where λ (nm) is the wavelength of the light beam.

12. The optical system according to claim 7, further comprising a fifth element group composed of a plurality of optical elements arranged so that the optical axis substantially coincides with a crystal axis [100] or a crystal axis optically equivalent to the crystal axis; and wherein
the fifth element group has a fifth A element group and a fifth B element group having a positional relationship rotated relative to each other by a sixth angle about the optical axis;
the optical path length L5A, of light beams having an angle of predetermined range with respect to the optical axis, in the optical elements in the fifth A element group, and the optical path length L5B of the light beams in the optical elements in the fifth B element group are substantially equal; and
a total optical path length L34 (=L3+L4), which is the sum of the optical path length L3 (=L3A+L3B), of light beams having an angle of the predetermined range with respect to the optical axis, in the optical elements in the third element group and the optical path length L4 (=L4A+L4B) of the light beams in the optical elements in the fourth element group, and the optical path length L5 (=L5A+L5B) in the optical elements in the fifth element group are set in accordance with a predetermined magnification.

13. The optical system according to claim 12, wherein the total optical path length L34 in the optical elements in the third element group and the fourth element group is set to approximately 4 times the optical path length L5 in the optical elements in the fifth element group.

14. The optical system according to claim 13, wherein the difference between 4 times the optical path length L5 in the optical elements in the fifth element group and the total optical path length L34 in the optical elements in the third element group and the fourth element group is set so as to not be greater than ±2.7×10⁻⁶×λ³ (cm), where λ (nm) is the wavelength of the light beam.

15. The optical system according to claim 12, wherein the difference between the optical path length L5A the optical elements in the fifth A element group and the optical path length L5B in the optical elements in the fifth B element group is set so as to not be greater than ±0.5×10⁻⁶×λ³ (cm), where λ (nm) is the wavelength of the light beam.

16. The optical system according to claim 7, wherein the angle within the predetermined range is larger than an angle corresponding to 0.6 times the image-side numerical aperture of the optical system while being smaller than an angle corresponding to 0.9 times the image-side numerical aperture.

17. The optical system according to claim 7, wherein the fifth A element group and the fifth B element group are positioned mutually close to each other along the optical axis.

18. An optical system that includes a plurality of optical elements formed of crystals belonging to a cubic system, comprising:
a sixth element group, a seventh element group, an eighth element group and a ninth element group, each composed of a plurality of optical elements arranged such that the optical axis of the optical system substantially coincides with a crystal axis [110] or a crystal axis optically equivalent to the crystal axis, and wherein:
the seventh element group has a positional relationship rotated by a seventh angle in a predetermined direction about the optical axis with respect to the sixth element group;
the eighth element group has a positional relationship rotated by the seventh angle in a predetermined direction about the optical axis with respect to the seventh element group;
the ninth element group has a positional relationship rotated by the seventh angle in a predetermined direction about the optical axis with respect to the eighth element group; and
the optical path length L6 in the optical elements in the sixth element group of light beams forming an angle of predetermined range with respect to the optical axis, the optical path length L7 in the optical elements in the seventh element group of light beams forming an angle of predetermined range with respect to the optical axis, the optical path length L8 in the optical elements in the eighth element group of light beams forming an angle of predetermined range with respect to the optical axis, and the optical path length L9 in the optical elements in the ninth element group of light beams forming an angle of predetermined range with respect to the optical axis, are all substantially equal to each other.

19. The optical system according to claim 18, wherein the difference between any two optical path lengths arbitrarily selected from among the optical path length L6 in the optical elements in the sixth element group, the optical path length L7 in the optical elements in the seventh element group, the optical path length L8 in the optical elements in the eighth element group, and the optical path length L9 in the optical elements in the ninth element group, is set so as to not be greater than ±0.5×10⁻⁶×λ³ (cm), where λ (nm) is the wavelength of the light beam.

20. The optical system according to claim 18, further comprising a tenth element group composed of a plurality of optical elements arranged such that the optical axis substantially coincides with a crystal axis [100] or a crystal axis optically equivalent to the crystal axis, wherein:
the tenth element group has a tenth A element group and a tenth B element group having a position relationship rotated relative to each other by an eighth angle about the optical axis; and
the optical path length L10A in the optical elements in the tenth A element group of the light beams forming the angle of predetermined range with respect to the optical axis, and the optical path length L10B in the optical elements in the tenth B element group are substantially equal.

21. The optical system according to claim 20, wherein the difference between the optical path length L10A in the optical elements in the tenth A element group and the optical path length L10B in the optical elements in the tenth B element group is set so as to not be greater than ±0.5×10⁻⁶×λ³ (cm), where λ (run) is the wavelength of the light beam.

22. The optical system according to claim 20, wherein the total optical path length L69 (=L6+L7+L8+L9), which is the sum of the optical path length L6 in the optical elements in the sixth element group and the optical path length L7 in the optical elements in the seventh element group and the optical path length L8 in the optical elements in the eighth element group and the optical path length L9 in the optical elements in the ninth element group, and the optical path length L10 (=L10A+L10B) in the optical elements in the tenth element group are set in accordance with a predetermined magnification.

23. The optical system according to claim 22, wherein the total optical path length L69 in the optical elements in the sixth element group through the ninth element group is set to approximately 4 times the optical path length L10 in the optical elements in the tenth element group.

24. The optical system according to claim 23, wherein the difference between 4 times the optical path length L10 in the optical elements in the tenth element group and the total optical path length L69 in the optical elements in the sixth element group through the ninth element group is set so as to not be greater than ±2.7×10⁻⁶×λ³ (cm), where λ (nm) is the wavelength of the light beam.

25. The optical system according to claim 18, further comprising an eleventh element group composed of a plurality of optical elements arranged such that the optical axis of the optical system substantially coincides with a crystal axis [111] or a crystal axis optically equivalent to the crystal axis, wherein:
the eleventh element group has an eleventh A element group and an eleventh B element group having a position relationship rotated relative to each other by an eighth angle about the optical axis; and
the optical path length L11A in the optical elements in the eleventh A element group of the light beams forming the angle of predetermined range with respect to the optical axis, and the optical path length L11B in the optical elements in the eleventh B element group are substantially equal.

26. The optical system according to claim 25, wherein the difference between the optical path length L11A in the optical elements in the eleventh A element group and the optical path length L11B in the optical elements in the eleventh B element group is set so as to not be greater than ±0.5×10⁻⁶×λ³ (cm), where λ (nm) is the wavelength of the light beam.

27. The optical system according to claim 25, wherein the sum (=3×L69+8×L11) of three times the total optical path length L69 in the optical elements in the sixth element group through the ninth element group with eight times the optical path length L11 in the optical elements in the 11th element group is set to approximately 12 times the optical path length L10 in the optical elements in the tenth element group.

28. The optical system according to claim 27, wherein the total optical path length L69 (cm) in the optical elements in the sixth element group through the ninth element group, the optical path length L10 (cm) in the optical elements in the tenth element group and the optical path length L11 (cm) in the optical elements in the 11th element group satisfy the condition:

|3×L69−12×L10+8×L11|≦8.0×10⁻⁶×λ³
where λ (nm) is the wavelength of the light beam.

29. The optical system according to claim 18, wherein the angle within the predetermined range is larger than an angle corresponding to 0.6 times the image-side numerical aperture of the optical system while being smaller than an angle corresponding to 0.9 times the image-side numerical aperture.

30. The optical system of claim 1, wherein the crystal is a calcium fluoride crystal or a barium fluoride crystal.

31. The optical system of claim 7, wherein the crystal is a calcium fluoride crystal or a barium fluoride crystal.

32. The optical system of claim 18, wherein the crystal is a calcium fluoride crystal or a barium fluoride crystal.

33. An exposure apparatus, comprising:
an illumination system for illuminating a mask, and
the optical system of claim 1 for forming on a photosensitive substrate an image of the pattern formed on the mask.

34. A microdevice fabrication method, comprising:
an exposure procedure that exposes the pattern on the mask onto the photosensitive substrate using the exposure apparatus according to claim 33, and
a developing procedure for developing the photosensitive substrate that has been exposed by the exposure procedure.

35. An exposure apparatus, comprising:
an illumination system for illuminating a mask, and
the optical system of claim 7 for forming on a photosensitive substrate an image of the pattern formed on the mask.

36. A microdevice fabrication method, comprising:
an exposure procedure that exposes the pattern on the mask onto the photosensitive substrate using the exposure apparatus according to claim 35, and
a developing procedure for developing the photosensitive substrate that has been exposed by the exposure procedure.

37. An exposure apparatus, comprising:
an illumination system for illuminating a mask, and
the optical system of claim 18 for forming on a photosensitive substrate an image of the pattern formed on the mask.

38. A microdevice fabrication method, comprising:
an exposure procedure that exposes the pattern on the mask onto the photosensitive substrate using the exposure apparatus according to claim 37, and
a developing procedure for developing the photosensitive substrate that has been exposed by the exposure procedure.
